(19) United States
(12) Patent Application Publication
(10) Pub. No.: US 2013/0229485 A1
(43) Pub. Date: Sep. 5, 2013

(54) Apparatus, a Method and a Computer Program for Video Coding and Decoding

(71) Applicants: Dmytro RUSANOVSKYY, Lempaala (FI); Miska Matias HANNUKSELA, Ruutana (FI); Wenyi SU, Anhui Province (CN)

(72) Inventors: Dmytro RUSANOVSKYY, Lempaala (FI); Miska Matias HANNUKSELA, Ruutana (FI); Wenyi SU, Anhui Province (CN)

(73) Assignee: NOKIA CORPORATION, Espoo (FI)

(21) Appl. No.: 13/599,219

(22) Filed: Aug. 30, 2012

Related U.S. Application Data
(60) Provisional application No. 61/529,037, filed on Aug. 30, 2011.
(60) Provisional application No. 61/561,528, filed on Nov. 18, 2011.

(51) Int. Cl. H04N 13/00

(52) U.S. Cl. CPC H04N 13/0048
USPC 348/43

(57) ABSTRACT

There is disclosed a method, an apparatus, a server, a client and a non-transitory computer readable medium comprising a computer program stored therein for motion compensated video coding and decoding. Texture block motion information is used to derive disparity/depth motion information. Alternatively, disparity/depth motion information is used to derive texture block motion information.

### TECHNICAL FIELD

The present invention relates to an apparatus, a method and a computer program for video coding and decoding.

### BACKGROUND INFORMATION

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

Several technologies for view rendering are available, and for example, depth image-based rendering (DIBR) has shown to be a competitive alternative. A typical implementation of DIBR takes stereoscopic video and corresponding depth information with stereoscopic baseline as input and synthesizes a number of virtual views between the two input views. Thus, DIBR algorithms may also enable extrapolation of views that are outside the two input views and not in between them. Similarly, DIBR algorithms may enable view synthesis from a single view of texture and the respective depth view.

In the encoding of 3D video content, video compression systems, such as Advanced Video Coding standard H.264/AVC or the Multiview Video Coding MVC extension of H.264/AVC can be used. However, the motion vector prediction specified in H.264/AVC/MVC may be not optimal for video coding systems utilizing inter-view and/or view synthesis prediction (VSP) along with inter prediction.

Thus, there is a need for improvements of the motion vector prediction (MVP) for the purposes of multi-view coding (MVC), depth-enhanced video coding, multiview+depth (MVD) coding and/or multi-view with in-loop view synthesis (MVC-VSP).

### SUMMARY

This invention proceeds from the consideration that the depth or disparity information (Di) for a current block (cb) of texture data is available through decoding of coded depth or disparity information or can be estimated at the decoder side prior to decoding of the current texture block cb, thus making it possible to utilize depth or disparity information in MVP process. The utilization of depth or disparity information (Di) in MVP improves compression in multi-view, multi-view+depth, and MVC-VSP coding systems.

In the description below the following naming convention is utilized. The cb term is used to note the current block of texture data, the depth or disparity information associated with cb is named as d(cb). The current block of texture data is defined as a texture block being coded by an encoder or encoding method or decoded by a decoder or decoding method.

During motion vector prediction (MVP) process for cb, encoder/decoder may use 2D blocks of texture data (A,B,C and so on).

These blocks are called adjacent blocks and they are spatially adjacent to cb image area (2D fragment of image adjacent to or surrounding the cb) and which is assumed to be available prior to coding/decoding of cb. See FIG. 15, where 2D image fragment adjacent to cb and utilized in MVP is shown in grey color.

In some cases, MVP process for cb may use adjacent 2D blocks of texture data (A,B,C and so on), which are located in 2D fragments of other images within the same video (video fragment) adjacent to the cb block, see FIG. 16. This video fragment is assumed to be available (coded/decoded) prior to coding/decoding of the cb.

In some cases, MVP process for cb may use adjacent 2D blocks of texture data (A,B,C and so on), which are located in 2D fragments of other images which are located in different views of the same multiview video data (multiview video fragment) adjacent to the cb block, see FIG. 16. Such multiview video fragment is assumed to be available (coded/decoded) prior to coding/decoding of the cb.

In other words, adjacent blocks A, B, C and so on may be located in spatio/temporal/inter-view proximity of the cb block in several 2D images which are available (coded/decoded) prior to the current image coding process.

Encoder/decoder can take in use motion information (such as horizontal motion vector component mv_x, vertical motion vector component mv_y, and reference frames which may be identified for example using reference frame indexes refIdx to one or more reference picture lists) associated with these blocks MV(A), MV(B), MV(C) as well as the depth/disparity information associated with these blocks, d(A), d(B), d(C), as they assumed to be available prior to coding/decoding cb. For simplicity of the description the following terms are equivalent of each other and their use refers to the same entities: cb and cb_t, Di(cb_t) and d(cb), Di(cb_t) and cb_d, mvX and MV(X), “neighboring block” and “adjacent block”.

Spatial resolution of an image is defined as the number of pixels (image samples) representing an image in horizontal and vertical direction. In the document below, expression “images at different resolution” can be interpreted as two images have different number of pixels either in horizontal direction, or in vertical direction, or in both directions.

Motion information can be of certain accuracy or precision MV(A) corresponding to a certain resolution. For example, the H.264/AVC coding standard uses ¼-pixel location motion vector precision, which in many implementations requires that the reference image is up-sampled by factor of 4× from the original image resolution along both coordinate axes. In the disclosure below terms motion vector resolution refer to the reference image resolution at which this motion vector is obtained during motion estimation procedure. For example, motion vector resolution is 4× relative to the original image resolution along both coordinate axes when ¼-pixel motion vector precision is in use. Many coding schemes pre-define the motion vector precision, although coding schemes of adaptive motion vector precision, where the motion vector precision is selected by the encoder have also been described. Encoder may choose motion vector accuracy, i.e. how accurately motion estimation is actually performed, to be lower than or equal to the precision, while many times encoders use motion vector accuracy equal to the precision. For example, in a coding scheme motion vectors are represented at ¼-pixel precision in the bitstream, but the encoder may choose to perform motion estimation at ½-pixel accuracy, i.e. search only full-pixel and ½-pixel positions. Many times, and also in this document, terms motion vector precision and accuracy may be used interchangeably as synonyms.

According to a first aspect of the invention, there is provided a method comprising: decoding, from a bitstream, a first coded texture block of a first coded texture picture into a first texture block cb, wherein the decoding the first coded texture block comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block A and the second adjacent texture block B on the basis a similarity value resulting from said comparison; deriving one or more prediction parameters for the decoding of the first coded texture block cb from values associated with the selected one or both of the first adjacent texture block A and the second adjacent texture block B; and decoding the first coded texture block cb using the derived one or more prediction parameters.

In the method of the first embodiment, said prediction parameters may include one or more of the following: a number of prediction blocks, such as uni- or bi-prediction; a type of one or more prediction references used, such as inter, inter-view and view synthesis; one or more reference pictures used; motion vector predictors or motion vectors to be applied a method of motion vector prediction to be applied; a zero-valued prediction error signal to be inferred.

The method of the first embodiment may further comprise conditioning the selection of one or both of the first adjacent texture block A and the second adjacent texture block B on the basis the similarity value resulting from said comparison on one or more threshold values obtained from the bitstream.

The method of the first embodiment may further comprise obtaining the first depth/disparity block d(cb) by decoding from the bitstream or by estimating.

In the method of the first embodiment, if no motion vector predictor is available for the coded texture block cb and a type of prediction reference for the coded texture block is inter-view, the method may further comprise setting the motion vector predictor to a value derived from the depth/disparity information of the current block of texture data d(cb).

In the method of the first embodiment, decoding a first coded texture block cb may comprise processing of more than two adjacent blocks.

In the method of the first embodiment, said selecting the first adjacent texture block A and the second adjacent texture block B for the first texture block cb may comprise one of the following: selecting the first adjacent texture block A and the second adjacent texture block B which are located in 2D fragment of image (set of pixels which belong to the same image) adjacent to or surrounding the cb; selecting the first adjacent texture block A and the second adjacent texture block B which are located in video fragment (set of pixels that belong to different images of the same video data) or multiview video fragment (set of pixels that belong to different images of the same multiview video data) adjacent to the cb block.

In the method of the first embodiment, said obtaining a depth/disparity block associated with adjacent texture block may comprise one or more of the following: selecting a first adjacent texture block Z and a second adjacent texture block Y; obtaining motion information MV(Z) utilized for decoding of the texture block Z and motion information MV(Y) utilized for decoding of the second adjacent texture block Y; obtaining one or more motion information candidates MV(X) obtained from the motion information MV(Z) and/or the motion information MV(Y); obtaining one or more motion information candidates MV(d(cb)) obtained from depth/disparity information d(cb) associated with first texture block cb; obtaining a texture block A through applying the motion information MV(Z) and counted from location of the first texture block cb; obtaining a texture block B through applying the motion information MV(Y) and counted from location of the first texture block cb; obtaining one or more texture blocks through applying the motion information MV(X) and counted from location of the first texture block cb; obtaining one or more texture blocks through applying motion information MV(d(cb)) and counted from location of the first texture block cb; obtaining a depth/disparity blocks d(A), d(B) and others associated with obtained texture blocks A,B and others.

In the method of the first embodiment, said selecting the first adjacent texture block A and the second adjacent texture block B for the first texture block cb may comprise one of the following: selecting a co-located block in a first reference picture as the first adjacent texture block A and selecting the second adjacent texture block B based on motion information or depth information associated with the first adjacent texture block, MV(A) and/or d(A); using the first depth/disparity block d(cb) for selecting a block in a second reference picture as the first adjacent texture block A and selecting the second adjacent texture block B based on values associated with the first adjacent texture block A; using the first depth/disparity block d(cb) for selecting a block in a third reference picture as the first adjacent texture block A and selecting the second adjacent texture block B which is located in 2D fragment of image or in video fragment or multiview video fragment adjacent to the first adjacent texture block A.

In the method of the first embodiment, if the texture image and the depth image associated with said texture image are presented at different spatial resolution, the method may comprise: spatial resolutions of texture and depth images are normalized by re-sampling of either one of component (texture or depth) to the resolution of another component (depth or texture), or both components are resampled to a single spatial resolution.

In the method of the first embodiment, if the texture image and the depth image associated with said texture image are presented at different spatial resolutions and resolution of depth image is different from resolution of texture image the method may comprise: motion information MV(A) and MV(B) of adjacent texture blocks A and B respectively are rescaled to meet spatial resolution of the depth image instead of resampling of depth image. Said motion information may include motion vector components motion vector components, motion partitions sizes and so on.

In the method of the first embodiment, if the texture image and the depth image associated with said texture image are presented at different spatial resolutions and resolution of depth image is different from resolution of texture image, the method may comprise: said comparison which produces similarity metric from application of motion information of adjacent texture blocks MV(A), MV(B) to depth image is adjusted to reflect the difference in resolution between texture and depth images. Said adjustment may be include decimation, subsampling, interpolation or upsampling depth information d(MV(A), d(cb)) and d(MV(B), d(cb)) to match with resolution of motion information obtained from adjacent texture blocks A, B and so on.

In the method of the first embodiment, if the texture image and the depth image associated with said texture image are presented at different resolution and/or depth data is presented in a form of non-uniform sampling or with use of sampling method which is different from the method utilized for representation of texture data, the method may comprise: said comparison which produces similarity metric from application of motion information of adjacent texture blocks MV(A), MV(B) to non-regularly sampled depth information is adjusted to reflect difference in representation or sampling method utilized for texture and depth data. Said adjustment may include resampling (downsampling, upsampling, resealing) of depth, texture or motion information, as well as linear and non-linear operations of merging or aggregating of depth information represented with non-uniform sampling method.

In the method of the first embodiment, if the texture image and the depth image associated with said texture image are presented at different spatial resolution and/or depth data is presented in a form of non-uniform sampling or with use of sampling method which is different from the method utilized for representation of texture data, the method may comprise: information required for decoding operation is signaled to decoder through the bitstream. Said information may include signaling of method utilized for spatial resolution normalization of texture and/or depth images, or signaling of methods utilized for resealing of motion information (e.g. rounding, downscaling/upscaling factor and so on), or signaling of method utilized for comparison adjustment (resealing, resampling or non-linear operations of merging or aggregation).

According to a second aspect of the invention, there is provided an apparatus comprising a video decoder configured for decoding, from a bitstream, a first coded texture block of a first coded texture picture into a first texture block cb, wherein the decoding the first coded texture block comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block (A or B) and the second adjacent texture block on the basis a similarity value resulting from said comparison between the first depth/disparity block d(cb) and the first adjacent depth/disparity block d(A), the second adjacent depth/disparity block d(B); deriving one or more prediction parameters for the decoding of the first coded texture block cb from values associated with the selected one or both of the first adjacent texture block A and the second adjacent texture block B; and decoding the first coded texture block cb using the derived one or more prediction parameters.

In the apparatus of the second embodiment, if the texture image and the depth image associated with said texture image are presented at different spatial resolution, the method may comprise: spatial resolutions of texture and depth images are normalized by in-loop re-sampling of either one of component (texture or depth) to the resolution of another component (depth or texture), or both components are resampled to a single spatial resolution.

In the apparatus of the second embodiment, if the texture image and the depth image associated with said texture image are presented at different spatial resolutions and resolution of depth image is different from resolution of texture image the method may comprise: motion information MV(A) and MV(B) of adjacent texture blocks A and B respectively are rescaled to meet spatial resolution of the depth image instead of resampling of depth image. Said motion information may include motion vector components motion vector components, motion partitions sizes and so on.

In the apparatus of the second embodiment, if the texture image and the depth image associated with said texture image are presented at different spatial resolutions and resolution of depth image is different from resolution of texture image, the method may comprise: said comparison which produces similarity metric from application of motion information of adjacent texture blocks MV(A), MV(B) to depth image is adjusted to reflect the difference in resolution between texture and depth images. Said adjustment may be include decimation, subsampling, interpolation or upsampling depth information d(MV(A), d(cb)) and d(MV(B), d(cb)) to match with resolution of motion information obtained from adjacent texture blocks A, B and so on.

In the apparatus of the second embodiment, if the texture image and the depth image associated with said texture image are presented at different resolution and/or depth data is presented in a form of non-uniform sampling or with use of sampling method which is different from the method utilized for representation of texture data, the method may comprise: said comparison which produces similarity metric from application of motion information of adjacent texture blocks MV(A), MV(B) to non-regularly sampled depth information is adjusted to reflect difference in representation or sampling method utilized for texture and depth data. Said adjustment may include resampling (downsampling, upsampling, resealing) of depth, texture or motion information, as well as linear and non-linear operations of merging or aggregating of depth information represented with non-uniform sampling method.

In the method of the second embodiment, if the texture image and the depth image associated with said texture image are presented at different spatial resolution and/or depth data is presented in a form of non-uniform sampling or with use of sampling method which is different from the method utilized for representation of texture data, the method may comprise: information required for decoding operation is decoded from the bitstream. Said information may include decoding indexes for method utilized for spatial resolution normalization of texture and/or depth images, or decoding indexes for methods utilized for resealing of motion information (e.g. rounding, downscaling/upscaling factor and so on), or decoding indexes for method utilized for comparison adjustment (resealing, resampling or non-linear operations of merging or aggregation).

According to a third aspect of the invention, there is provided a computer readable storage medium stored with code thereon for use by an apparatus, which when executed by a processor, causes the apparatus to perform: decoding, from a bitstream, a first coded texture block of a first coded texture picture into a first texture block cb, wherein the decoding the first coded texture block comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block (A or B) and the second adjacent texture block on the basis a similarity value resulting from said comparison between the first depth/disparity block d(cb) and the first adjacent depth/disparity block d(A), the second adjacent depth/disparity block d(B);deriving one or more prediction parameters for the decoding of the first coded texture block cb from values associated with the selected one or both of the first adjacent texture block A and the second adjacent texture block B; and decoding the first coded texture block cb using the derived one or more prediction parameters.

According to a fourth aspect of the invention there is provided an apparatus comprising at least one processor and at least one memory, said at least one memory stored with code thereon, which when executed by said at least one processor, causes an apparatus to perform: decoding, from a bitstream, a first coded texture block of a first coded texture picture into a first texture block cb, wherein the decoding the first coded texture block comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block (A or B) and the second adjacent texture block on the basis a similarity value resulting from said comparison between the first depth/disparity block d(cb) and the first adjacent depth/disparity block d(A), the second adjacent depth/disparity block d(B); deriving one or more prediction parameters for the decoding of the first coded texture block cb from values associated with the selected one or both of the first adjacent texture block A and the second adjacent texture block B; and decoding the first coded texture block cb using the derived one or more prediction parameters.

According to a fifth aspect of the invention, there is provided a video decoder configured for decoding, from a bitstream, a first coded texture block of a first coded texture picture into a first texture block cb, wherein the decoding the first coded texture block comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block A and the second adjacent texture block B on the basis a similarity value resulting from said comparison between the first depth/disparity block d(cb) and the first adjacent depth/disparity block d(A), the second adjacent depth/disparity block d(B); deriving one or more prediction parameters for the decoding of the first coded texture block cb from values associated with the selected one or both of the first adjacent texture block A and the second adjacent texture block B; and coding/decoding the first coded texture block cb using the derived one or more prediction parameters.

According to a sixth aspect of the invention, there is provided a method comprising: encoding a first uncompressed texture block cb of a first uncompressed texture picture into a first coded texture block of a first coded texture picture of a bitstream, wherein the encoding the first uncompressed texture block cb comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block (A or B) and the second adjacent texture block on the basis a similarity value resulting from said comparison between the first depth/disparity block d(cb) and the first adjacent depth/disparity block d(A), the second adjacent depth/disparity block d(B); deriving one or more prediction parameters for the encoding of the first coded texture block cb from values associated with the selected one or both of the first adjacent texture block A and the second adjacent texture block B; and encoding the first uncompressed texture block cb using the derived one or more prediction parameters into the first coded texture block.

According to a seventh aspect of the invention, there is provided an apparatus comprising a video encoder configured for encoding a first uncompressed texture block cb of a first uncompressed texture picture into a first coded texture block of a first coded texture picture of a bitstream, wherein the encoding the first uncompressed texture block cb comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block A and the second adjacent texture block B on the basis a similarity value resulting from said comparison between the first depth/disparity block d(cb) and the first adjacent depth/disparity block d(A), the second adjacent depth/disparity block d(B); deriving one or more prediction parameters for the encoding of the first coded texture block cb from values associated with the selected one or both of the first adjacent texture block A and the second adjacent texture block B; and encoding the first uncompressed texture block cb using the derived one or more prediction parameters into the first coded texture block.

According to an eight aspect of the invention, there is provided a computer readable storage medium stored with code thereon for use by an apparatus, which when executed by a processor, causes the apparatus to perform: encoding a first uncompressed texture block cb of a first uncompressed texture picture into a first coded texture block of a first coded texture picture of a bitstream, wherein the encoding the first uncompressed texture block cb comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block A and the second adjacent texture block B on the basis a similarity value resulting from said comparison between the first depth/disparity block d(cb) and the first adjacent depth/disparity block d(A), the second adjacent depth/disparity block d(B); deriving one or more prediction parameters for the encoding of the first coded texture block cb from values associated with the selected one or both of the first adjacent texture block A and the second adjacent texture block B; and encoding the first uncompressed texture block cb using the derived one or more prediction parameters into the first coded texture block.

According to a ninth aspect of the invention, there is provided at least one processor and at least one memory, said at least one memory stored with code thereon, which when executed by said at least one processor, causes an apparatus to perform: encoding a first uncompressed texture block cb of a first uncompressed texture picture into a first coded texture block of a first coded texture picture of a bitstream, wherein the encoding the first uncompressed texture block cb comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block A and the second adjacent texture block B on the basis a similarity value resulting from said comparison between the first depth/disparity block d(cb) and the first adjacent depth/disparity block d(A), the second adjacent depth/disparity block d(B); deriving one or more prediction parameters for the encoding of the first coded texture block cb from values associated with the selected one or both of the first adjacent texture block A and the second adjacent texture block B; and encoding the first uncompressed texture block cb using the derived one or more prediction parameters into the first coded texture block.

According to a tenth aspect of the invention, there is provided a video encoder configured for encoding a first uncompressed texture block cb of a first uncompressed texture picture into a first coded texture block of a first coded texture picture of a bitstream, wherein the encoding the first uncompressed texture block cb comprises: selecting a first adjacent texture block A and a second adjacent texture block B; obtaining a first adjacent depth/disparity block d(A) and a second adjacent depth/disparity d(B); obtaining a first depth/disparity block d(cb) spatially co-located with the first texture block cb; comparing the first depth/disparity block d(cb) with the first adjacent depth/disparity block d(A) and the second adjacent depth/disparity block d(B); selecting one or both of the first adjacent texture block A and the second adjacent texture block B on the basis a similarity value resulting from said comparison between the first depth/disparity block d(cb) and the first adjacent depth/disparity block d(A), the second adjacent depth/disparity block d(B); deriving one or more prediction parameters for the encoding of the first coded texture block cb from values associated with the selected one or both of the first adjacent texture block A and the second adjacent texture block B; and encoding the first uncompressed texture block cb using the derived one or more prediction parameters into the first coded texture block.

According to eleventh aspect of the invention, the method comprises encoding a first data element with a first method being the method of the first embodiment; calculating a first cost metric Cost1 for the coded first data element; encoding a second data element with a second method being a motion vector prediction method alternative to the first method; calculating a second cost metric Cost2 for coded second data element; selecting between the first and the second method a method which is determined to be optimal with respect to first and second cost metrics Cost1 and Cost2; encoding the first and second data elements with the selected method; signalling an index indicating the selected method through the bitstream.

In the method of the eleventh embodiment, a first data element may include either a single texture block Cb or a set of coded blocks (slice, image, group of images).

In the method of the eleventh embodiment, the second data element may include a set of texture block (A, B).

In the method of the eleventh embodiment, said cost metric can be compound of rate-distortion metric, or other cost metrics, such as rate-distortion-complexity metric.

In the method of the eleventh embodiment, said signaling is performed at the various level of the coded data representation.

In the method of eleventh embodiment, the index is signaled in at least one of the following: at the sequence parameters set, at picture parameters set, at the slice header or along with motion information for a particular block partition.

According to twelfth aspect of the invention, the method comprises decoding, from a bitstream, an index indicating a method being utilized for decoding of a data set: decoding, from a bitstream, decoded data set specification where said method being indicated by the index is applicable; applying a first method being the method of claim 1 if decoding of bitstream specified so; applying a second method being a motion vector prediction method alternative to the first method if decoding of bitstream specified so.

### DESCRIPTION OF THE DRAWINGS

For better understanding of the present invention, reference will now be made by way of example to the accompanying drawings in which:

FIG. 1 shows a simplified 2D model of a stereoscopic camera setup;

FIG. 2 shows a simplified model of a multiview camera setup;

FIG. 3 shows a simplified model of a multiview autostereoscopic display (ASD);

FIG. 4 shows a simplified model of a DIBR-based 3DV system;

FIGS. 5 and 6 show an example of a TOF-based depth estimation system;

FIGS. 7a and 7b show the spatial and temporal neighbourhood of the currently coded block serving as the candidates for MVP in H.264/AVC;

FIG. 8 shows a flow chart of a depth/disparity information based MVP according to an embodiment of the invention;

FIG. 9 shows a flow chart of a depth/disparity information based MVP according to another embodiment of the invention;

FIG. 10 shows schematically an electronic device suitable for employing some embodiments of the invention;

FIG. 11 shows schematically a user equipment suitable for employing some embodiments of the invention;

FIG. 12 further shows schematically electronic devices employ embodiments of the invention connected using wireless and wired network connections;

FIG. 13 shows an example of blocks layout cb, A, B, C, D;

FIG. 14 shows blocks of texture data (cb, S, T, U) and depth/disparity data associated with these blocks, d(cb), d(S), d(T) and d(U) respectively;

FIG. 15 shows conception of spatially adjacent blocks of texture data

FIG. 16 shows conception of adjacent blocks in 2D texture or multiview texture data;

FIG. 17 shows flowchart of an example of implementation for depth-based motion vector competition in Skip mode for P-slices;

FIG. 18 shows flowchart of an example of implementation for depth-based motion vector competition in Direct mode for B-slices;

FIG. 19 shows a flowchart of possible motion vector prediction (MVP) process;

FIG. 20 shows reference non-uniformed sampled depth image and reference uniformly sampled texture image;

FIG. 21 shows an example of mapping of a depth map into another view;

FIG. 22 shows an example of generation of an initial depth map estimate after coding a first dependent view of a random access unit;

FIG. 23 shows an example of derivation of a depth map estimate for the current picture using motion parameters of an already coded view of the same access unit; and

FIG. 24 shows an example of updating of a depth map estimate for a dependent view based on coded motion and disparity vectors;

### DETAILED DESCRIPTION OF SOME EXAMPLE EMBODIMENTS OF THE INVENTION

In order to understand the various aspects of the invention and the embodiments related thereto, the following describes briefly some closely related aspects of video coding. Some key definitions, bitstream and coding structures, and concepts of H.264/AVC are described in this section as an example of a video encoder, decoder, encoding method, decoding method, and a bitstream structure, wherein the embodiments may be implemented. The aspects of the invention are not limited to H.264/AVC, but rather the description is given for one possible basis on top of which the invention may be partly or fully realized.

The H.264/AVC standard was developed by the Joint Video Team (JVT) of the Video Coding Experts Group (VCEG) of the Telecommunications Standardisation Sector of International Telecommunication Union (ITU-T) and the Moving Picture Experts Group (MPEG) of International Standardisation Organisation (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

High Efficiency Video Coding (HEVC) is another and more recent development of video coding technology by the Joint Collaborative Team-Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in the current working draft of HEVC—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD), which is specified in Annex C of H.264/AVC. The standard contains coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder is a picture. A picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes and consequently a macroblock contains one 8×8 block of chroma samples per each chroma component. A picture is partitioned to one or more slice groups, and a slice group contains one or more slices. A slice consists of an integer number of macroblocks ordered consecutively in the raster scan within a particular slice group.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In a draft HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In the current working draft of HEVC, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a HEVC WD5 is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD5, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD5, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

The elementary unit for the output of an H.264/AVC or HEVC encoder and the input of an H.264/AVC or HEVC decoder is a Network Abstraction Layer (NAL) unit. Decoding of partially lost or corrupted NAL units is typically difficult. For transport over packet-oriented networks or storage into structured files, NAL units are typically encapsulated into packets or similar structures. A bytestream format has been specified in H.264/AVC or HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention is performed always regardless of whether the bytestream format is in use or not.

Some profiles of H.264/AVC enable the use of up to eight slice groups per coded picture. When more than one slice group is in use, the picture is partitioned into slice group map units, which are equal to two vertically consecutive macroblocks when the macroblock-adaptive frame-field (MBAFF) coding is in use and equal to a macroblock otherwise. The picture parameter set contains data based on which each slice group map unit of a picture is associated with a particular slice group. A slice group can contain any slice group map units, including non-adjacent map units. When more than one slice group is specified for a picture, the flexible macroblock ordering (FMO) feature of the standard is used.

In H.264/AVC, a slice consists of one or more consecutive macroblocks (or macroblock pairs, when MBAFF is in use) within a particular slice group in raster scan order. If only one slice group is in use, H.264/AVC slices contain consecutive macroblocks in raster scan order and are therefore similar to the slices in many previous coding standards. In some profiles of H.264/AVC slices of a coded picture may appear in any order relative to each other in the bitstream, which is referred to as the arbitrary slice ordering (ASO) feature. Otherwise, slices must be in raster scan order in the bitstream.

NAL units consist of a header and payload. The NAL unit header indicates the type of the NAL unit and whether a coded slice contained in the NAL unit is a part of a reference picture or a non-reference picture. In H.264/AVC and HEVC, the NAL unit header indicates the type of the NAL unit and whether a coded slice contained in the NAL unit is a part of a reference picture or a non-reference picture. H.264/AVC includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units additionally contains various indications related to the scalability and multiview hierarchy.

In H.264/AVC and HEVC, NAL units can be categorized into Video Coding Layer (VCL) NAL units and non-VCL NAL units.

In H.264/AVC, VCL NAL units are either coded slice NAL units, coded slice data partition NAL units, or VCL prefix NAL units. Coded slice NAL units contain syntax elements representing one or more coded macroblocks, each of which corresponds to a block of samples in the uncompressed picture. There are four types of coded slice NAL units: coded slice in an Instantaneous Decoding Refresh (IDR) picture, coded slice in a non-IDR picture, coded slice of an auxiliary coded picture (such as an alpha plane) and coded slice extension (for SVC slices not in the base layer or MVC slices not in the base view). A set of three coded slice data partition NAL units contains the same syntax elements as a coded slice. Coded slice data partition A comprises macroblock headers and motion vectors of a slice, while coded slice data partition B and C include the coded residual data for intra macroblocks and inter macroblocks, respectively. It is noted that the support for slice data partitions is only included in some profiles of H.264/AVC. A VCL prefix NAL unit precedes a coded slice of the base layer in SVC and MVC bitstreams and contains indications of the scalability hierarchy of the associated coded slice.

In HEVC, coded slice NAL units contain syntax elements representing one or more CU. In HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture).

A non-VCL NAL unit may be for example of one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets are essential for the reconstruction of decoded pictures, whereas the other non-VCL NAL units are not necessary for the reconstruction of decoded sample values and serve other purposes presented below.

Parameters that remain unchanged through a coded video sequence are included in a sequence parameter set. In addition to the parameters that are essential to the decoding process, the sequence parameter set may optionally contain video usability information (VUI), which includes parameters that are important for buffering, picture output timing, rendering, and resource reservation. A picture parameter set contains such parameters that are likely to be unchanged in several coded pictures. No picture header is present in H.264/AVC bitstreams but the frequently changing picture-level data is repeated in each slice header and picture parameter sets carry the remaining picture-level parameters. H.264/AVC syntax allows many instances of sequence and picture parameter sets, and each instance is identified with a unique identifier. Each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets using a more reliable transmission mechanism compared to the protocols used for the slice data. For example, parameter sets can be included as a parameter in the session description for H.264/AVC Real-time Transport Protocol (RTP) sessions. If parameter sets are transmitted in-band, they can be repeated to improve error robustness.

In a draft HEVC, there is also a third type of parameter sets, here referred to as Adaptation Parameter Set (APS), which includes parameters that are likely to be unchanged in several coded slices. In a draft HEVC, the APS syntax structure includes parameters or syntax elements related to context-based adaptive binary arithmetic coding (CABAC), adaptive sample offset, adaptive loop filtering, and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS.

An SEI NAL unit contains one or more SEI messages, which are not required for the decoding of output pictures but assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contains the syntax and semantics for the specified SEI messages but no process for handling the messages in the recipient is defined. Consequently, encoders are required to follow the H.264/AVC or HEVC standard when they create SEI messages, and decoders conforming to the H.264/AVC or HEVC standard are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture in H.264/AVC consists of the VCL NAL units that are required for the decoding of the picture. A coded picture can be a primary coded picture or a redundant coded picture. A primary coded picture is used in the decoding process of valid bitstreams. In H.264/AVC, a redundant coded picture is a redundant representation that should only be decoded when the primary coded picture cannot be successfully decoded.

In H.264/AVC, an access unit consists of a primary coded picture and those NAL units that are associated with it. The appearance order of NAL units within an access unit is constrained as follows. An optional access unit delimiter NAL unit may indicate the start of an access unit. It is followed by zero or more SEI NAL units. The coded slices or slice data partitions of the primary coded picture appear next, followed by coded slices for zero or more redundant coded pictures.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit always results in one decoded picture consisting of one or more decoded view components. In other words, an access unit in MVC contains the view components of the views for one output time instance.

A view component in MVC is referred to as a coded representation of a view in a single access unit. An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) is and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. A closed GOP is such a group of pictures in which all pictures can be correctly decoded when the decoding starts from the initial intra picture of the closed GOP. In other words, no picture in a closed GOP refers to any pictures in previous GOPs. In H.264/AVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC indicates whether a particular picture is a reference picture for inter prediction of any other picture. Pictures of any coding type (I, P, B) can be reference pictures or non-reference pictures in H.264/AVC. The NAL unit header indicates the type of the NAL unit and whether a coded slice contained in the NAL unit is a part of a reference picture or a non-reference picture.

Many hybrid video codecs, including H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may be also referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as motion vector that indicates the position of the prediction block compared to the block being coded.

Inter prediction process may be characterized using one or more of the following factors.

The accuracy of motion vector representation. For example, motion vectors may be of quarter-pixel accuracy, and sample values in fractional-pixel positions are obtained using a finite impulse response (FIR) filter.

Block partitioning for inter prediction. Many coding standards, including H.264/AVC and HEVC, allow selection of the size and shape of the block for which a motion vector is applied for motion-compensated in the encoder, and indicating the selected size and shape in the bitstream so that decoders can reproduce the motion-compensated prediction done in the encoder.

A basic unit for inter prediction in many coding standards including H.264/AVC is a macroblock, corresponding to a 16×16 block of luma samples and corresponding chroma samples. In H.264/AVC, a macroblock can be further divided to 16×8, 8×16, or 8×8 macroblock partitions, and the 8×8 partition can be further divided to 4×4, 4×8, or 8×4 sub-macroblock partitions, and a motion vector is coded for each partition. In the following, a block is used to refer to a unit for inter prediction, which may be of a different level in the partitioning structure. For example in the case of H.264/AVC, a block in the following may refer to a macroblock, a macroblock partition or a sub-macroblock partition, whichever is used as a unit for inter prediction.

Number of reference pictures for inter prediction. The sources of inter prediction are previously decoded pictures. Many coding standards, including H.264/AVC and HEVC, enable storage of multiple reference pictures for inter prediction and selection of the used reference picture on macroblock or macroblock partition basis.

Motion vector prediction. In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Differential coding of motion vectors is typically disabled across slice boundaries.

Multi-hypothesis motion-compensated prediction. H.264/AVC and HEVC enable the use of a single prediction block in P and SP slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P or SP slices may be uni-predicted or intra-predicted. In H.264/AVC and HEVC, the reference pictures for a bi-predictive picture are not limited to be the subsequent picture and the previous picture in output order, but rather any reference pictures can be used.

In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to predicting from a reference picture in reference picture list 0, and prediction in backward direction may refer to predicting from a reference picture in reference picture list 1, even though the reference pictures for prediction may have any decoding or output order relation to each other or to the current picture.

Weighted prediction. Many coding standards use a prediction weight of 1 for prediction blocks of inter (P) pictures and 0.5 for each prediction block of a B picture (resulting into averaging). Many coding standards, such as H.264/AVC and HEVC, allow weighted prediction for both P and B slices. In implicit weighted prediction, the weights are proportional to picture order counts, while in explicit weighted prediction, prediction weights are explicitly indicated.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the said TU (including e.g. DCT coefficient information). It is typically signaled at CU level whether prediction error coding is applied or not for each CU. In the case there is no prediction error residual associated with the CU, it can be considered there are no TUs for the said CU.

In some coding formats and codecs, a distinction is made between so-called short-term and long-term reference pictures. This distinction may affect some decoding processes such as motion vector scaling in the temporal direct mode or implicit weighted prediction. If both of used reference pictures for the temporal direct mode are short-term reference pictures, the motion vector used in the prediction may be scaled according to the POC difference between the current picture and each of the reference pictures. However, if at least one reference picture for the temporal direct mode is a long-term reference picture, default scaling of the motion vector is used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, the a default prediction weight may be used, such as 0.5 in implicit weighted prediction for bi-predicted blocks.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control requires the presence of memory management control operation (MMCO) parameters in the bitstream. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a working draft 5 of HEVC, reference picture marking syntax structures and related decoding processes have been removed and a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the a reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to the reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set. A reference picture set may be specified in a picture parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFo110, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC provides a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as reference and needed for output.

In many coding modes of H.264/AVC and HEVC, the reference picture for inter prediction is indicated with an index to a reference picture list. The index is coded with variable length coding, i.e., the smaller the index is, the shorter the corresponding syntax element becomes.

Typical high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU comprises 1) The information whether ‘the PU is uni-predicted using only reference picture list0’ or ‘the PU is uni-predicted using only reference picture list1’ or ‘the PU is bi-predicted using both reference picture list0 and list1’ 2) Motion vector value corresponding to the reference picture list0 3) Reference picture index in the reference picture list0 4) Motion vector value corresponding to the reference picture list1 5) Reference picture index in the reference picture list1. Similarly, predicting the motion information is carried out using the motion information of adjacent blocks and/or co-located blocks in temporal reference pictures. Typically, a list, often called as merge list, is constructed by including motion prediction candidates associated with available adjacent/co-located blocks and the index of selected motion prediction candidate in the list is signalled. Then the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism is also employed for individual PUs (not necessarily the whole CU as in skip mode) and in this case, prediction residual may be utilized to improve prediction quality. This type of prediction mode is typically named as inter-merge mode.

A reference picture list is constructed in two steps: first, an initial reference picture list is generated. The initial reference picture list may be generated for example on the basis of frame_num, POC, temporal_id, and/or reference picture set. Second, the initial reference picture list may be reordered by reference picture list reordering (RPLR) commands contained in slice headers. The RPLR commands indicate the pictures that are ordered to the beginning of the respective reference picture list. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

The merge list may be generated on the basis of reference picture list 0 and/or reference picture list 1 for example using the reference picture lists combination syntax structure included in the slice header syntax. There may be a reference picture lists combination syntax structure, created into the bitstream by an encoder and decoded from the bitstream by a decoder, which indicates the contents of the merge list. The syntax structure may indicate that the reference picture list 0 and the reference picture list 1 are combined to be an additional reference picture lists combination used for the prediction units being uni-directional predicted. The syntax structure may include a flag which, when equal to a certain value, indicates that the reference picture list 0 and reference picture list 1 are identical thus reference picture list 0 is used as the reference picture lists combination. The syntax structure may include a list of entries, each specifying a reference picture list (list 0 or list 1) and a reference index to the specified list, where an entry specifies a reference picture to be included in the merge list.

In H.264/AVC, the frame_num syntax element is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

In H.264/AVC and HEVC, a value of picture order count (POC) is derived for each picture and is non-decreasing with increasing picture position in output order relative to the previous IDR picture or a picture containing a memory management control operation marking all pictures as “unused for reference”. POC therefore indicates the output order of pictures. It is also used in the decoding process for implicit scaling of motion vectors in the temporal direct mode of bi-predictive slices, for implicitly derived weights in weighted prediction, and for reference picture list initialization of B slices. Furthermore, POC is used in the verification of output order conformance.

In MVC, view dependencies are specified in the sequence parameter set (SPS) MVC extension. The dependencies for anchor pictures and non-anchor pictures are independently specified. Therefore anchor pictures and non-anchor pictures can have different view dependencies. However, for the set of pictures that refer to the same SPS, all the anchor pictures have the same view dependency, and all the non-anchor pictures have the same view dependency. Furthermore, in the SPS MVC extension, dependent views are signaled separately for the views used as reference pictures in reference picture list 0 and for the views used as reference pictures in reference picture list 1.

In MVC, there is an “inter_view_flag” in the network abstraction layer (NAL) unit header which indicates whether the current picture is not used or is allowed to be used for inter-view prediction for the pictures in other views. Non-reference pictures (with “nal_ref_idc” equal to 0) that are used as for inter-view prediction reference (i.e. having “inter_view_flag” equal to 1) are called inter-view only reference pictures. Pictures with “nal_ref_idc” greater than 0 and that are used for inter-view prediction reference (i.e. having “inter_view_flag equal to 1”) are called inter-view reference pictures.

In MVC, inter-view prediction is supported by texture prediction (i.e., the reconstructed sample values may be used for inter-view prediction), and only the decoded view components of the same output time instance (i.e., the same access unit) as the current view component are used for inter-view prediction. The fact that reconstructed sample values are used in inter-view prediction also implies that MVC utilizes multi-loop decoding. In other words, motion compensation and decoded view component reconstruction are performed for each view.

The process of constructing reference picture lists in MVC is summarized as follows. First, an initial reference picture list is generated in two steps: i) An initial reference picture list is constructed including all the short-term and long-term reference pictures that are marked as “used for reference” and belong to the same view as the current slice as done in H.264/AVC. Those short-term and long-term reference pictures are named intra-view references for simplicity. ii) Then, inter-view reference pictures and inter-view only reference pictures are appended after the intra-view references, according to the view dependency order indicated in the active SPS and the “inter_view_flag” to form an initial reference picture list.

After the generation of an initial reference picture list in MVC, the initial reference picture list may be reordered by reference picture list reordering (RPLR) commands which may be included in a slice header. The RPLR process may reorder the intra-view reference pictures, inter-view reference pictures and inter-view only reference pictures into a different order than the order in the initial list. Both the initial list and final list after reordering must contain only a certain number of entries indicated by a syntax element in the slice header or the picture parameter set referred by the slice.

A texture view refers to a view that represents ordinary video content, for example has been captured using an ordinary camera, and is usually suitable for rendering on a display.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

Depth-enhanced video may be coded in a manner where texture and depth are coded independently of each other. For example, texture views may be coded as one MVC bitstream and depth views may be coded as another MVC bitstream. Alternatively depth-enhanced video may be coded in a manner where texture and depth are jointly coded. When joint coding texture and depth views is applied for a depth-enhanced video representation, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture.

In the case of joint coding of texture and depth for depth-enhanced video, view synthesis can be utilized in the loop of the codec, thus providing view synthesis prediction (VSP). In VSP, a prediction signal, such as a VSP reference picture, is formed using a DIBR or view synthesis algorithm, utilizing texture and depth information. For example, a synthesized picture (i.e., VSP reference picture) may be introduced in the reference picture list in a similar way as it is done with interview reference pictures and inter-view only reference pictures. Alternatively or in addition, a specific VSP prediction mode for certain prediction blocks may be determined by the encoder, indicated in the bitstream by the encoder, and used as concluded from the bitstream by the decoder.

In MVC, both inter prediction and inter-view prediction use essentially the same motion-compensated prediction process. Inter-view reference pictures and inter-view only reference pictures are essentially treated as long-term reference pictures in the different prediction processes. Similarly, view synthesis prediction may be realized such a manner that it uses the essentially the same motion-compensated prediction process as inter prediction and inter-view prediction. To differentiate from motion-compensated prediction taking place only within a single view without any VSP, motion-compensated prediction that includes and is capable of flexibly selecting mixing inter prediction, inter-prediction, and/or view synthesis prediction is herein referred to as mixed-direction motion-compensated prediction.

As reference picture lists in MVC and MVD may contain more than one type of reference pictures, i.e. inter reference pictures (also known as intra-view reference pictures), inter-view reference pictures, inter-view only reference pictures, and VSP reference pictures, a term prediction direction is defined to indicate the use of intra-view reference pictures (temporal prediction), inter-view prediction, or VSP. For example, an encoder may choose for a specific block a reference index that points to an inter-view reference picture, thus the prediction direction of the block is inter-view.

Motion vector (MV) prediction specified in H.264/AVC/MVC utilizes correlation which is present in neighboring blocks of the same image (spatial correlation) or in the previously coded image (temporal correlation). The motion vectors (MVs) of a currently coded block (cb) are estimated through a motion estimation and motion compensation process and are coded in differential pulse code modulation (DPCM) manner and transmitted in the form of a residual or a motion vector difference (MVd) between the motion vector prediction/predictor (MVp) and the actual MV as MVd(x, y)=MV(x, y)−MVp(x, y). The horizontal residual component MVd(x)=MV(x)−MVp(x) may be coded and transmitted in a separate codeword from the vertical residual component MVd(y)=MV(y)−MVp(y).

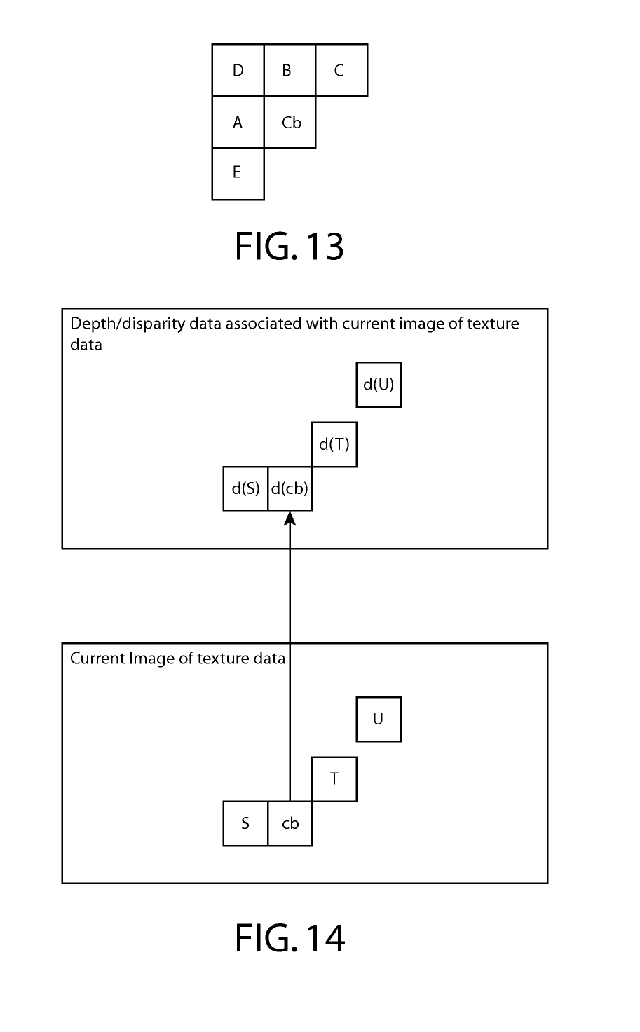

In H.264/AVC motion vector components MVd(x) and MVd(y) for P macroblocks or macroblock partitions (block cb, see FIG. 13) are differentially coded using either median or directional prediction from spatially neighboring blocks, wherein a neighboring block may be a macroblock, macroblock partition or a sub-macroblock partition. FIG. 13 illustrates labeling of spatially neighboring blocks for the current block cb. In H.264/AVC, blocks A to D may be used as motion vector prediction sources for various prediction modes. In other coding methods, other neighboring blocks, such as block E, may be used as as motion vector prediction source.

Directional motion vector prediction is used for certain shapes of macroblock partitions, namely 8×16 and 16×8, when the reference index of cb is the same as in certain spatially neighboring block determined by the shape of the current macroblock partition and its location within the current macroblock. In directional motion vector prediction, the motion vector of certain block is taken as the motion vector predictor for the current macroblock partition.

Please refer to FIG. 13 for an illustration of the location of neighboring blocks A to C relative to the current block cb. In median motion vector prediction of H.264/AVC, inherited in MVC as well, the reference indices of the neighboring blocks immediately above (block B), diagonally above and to the right (block C), and immediately left (block A) of the current block cb are first compared to the reference index of cb. If one and only one of the reference indices of blocks A, B, and C is equal to the reference index of cb, then the motion vector predictor for cb is equal to the motion vector of the block A, B, or C for which the reference index is equal to the reference index of cb. Otherwise, the motion vector predictor for cb is derived as a median value of the motion vectors of blocks A, B, and C regardless of their reference index value. FIG. 7a shows how blocks A, B, and C are spatially related to the currently coded block (cb).

In other words, the median motion vector prediction process for deriving MVp is specified in H.264/AVC as follows:

1. When only one of the spatial neighboring blocks (A,B,C) has identical reference index as the current block (cb):

MVp=mvN, where N is one of(A,B,C)

2. When more than one or no neighboring blocks (A,B,C) have identical reference index as the cb:

MVp=median{mvA,mvB,mvC},

where mvA, mvB, mvC are motion vectors (without reference index) of the spatially neighboring blocks.

In H.264/AVC, the motion vectors and reference indexes for the neighboring blocks A, B, C of the current block cb are determined based on their availability as follows. If the top-right (C) block is not available, for example when it is in a different slice than cb or outside picture boundaries, the location on the top-right (C) is replaced with the top-left block (D). If a block A, B, or C is not available, for example it is in a different slice than cb or outside picture boundaries or coded in intra mode, the motion vector mvA, mvB, or mvC, respectively, is equal to 0 and the reference index for block A, B, or C, respectively is −1 for motion vector prediction and mixed-direction motion-compensated prediction.

In addition to the motion-compensated macroblock modes for which a differential motion vector is coded, a P macroblock may also be coded in the so-called P_Skip type in H.264/AVC. For this coding type, no differential motion vector, reference index, or quantized prediction error signal is coded into the bitstream. The reference picture of a macroblock coded with the P_Skip type has index 0 in reference picture list 0. The motion vector used for reconstructing the P_Skip macroblock is obtained using median motion vector prediction for the macroblock without any differential motion vector being added. P_Skip may be beneficial for compression efficiency particularly in areas where the motion field is smooth.

In B slices of H.264/AVC, four different types of inter prediction are supported: uni-predictive from reference picture list 0, uni-directional from reference picture list 1, bi-predictive, direct prediction, and B_skip. The type of inter prediction can be selected separately for each macroblock partition. B slices utilize a similar macroblock partitioning as P slices. For a bi-predictive macroblock partition, the prediction signal is formed by a weighted average of motion-compensated list 0 and list 1 prediction signals. Reference indices, motion vector differences, as well as quantized prediction error signal may be coded for uni-predictive and bi-predictive B macroblock partitions.

Two direct modes are included in H.264/AVC, temporal direct and spatial direct, and one of them can be selected into use for a slice in a slice header. In the temporal direct mode, the reference index for reference picture list 1 is set to 0 and the reference index for reference picture list 0 is set to point to the reference picture that is used in the co-located block (compared to cb) of the reference picture having index 0 in the reference picture list 1 if that reference picture is available, or set to 0 if that reference picture is not available. The motion vector predictor for cb is essentially derived by considering the motion information within a co-located block of the reference picture having index 0 in reference picture list 1. Motion vector predictors for a temporal direct block are derived by scaling a motion vector from the co-located block where the scaling weight is proportional to picture order count differences between the current picture and the reference pictures associated with the inferred reference indexes in list 0 and list 1, and by selecting the sign for the motion vector predictor depending on which reference picture list it is using. FIG. 7b shows an example illustration of co-located blocks of the currently coded block (cb) for MVP of the temporal direct mode of H.264/AVC. The use of temporal direct mode is not supported in any present coding profile for MVC, even though the syntax of the standard supports also the temporal direct mode.

In spatial direct mode of H.264/AVC, motion information of spatially adjacent blocks is exploited in a similar manner to P blocks. Motion vector prediction in spatial direct mode can be divided into three steps: reference index determination, determination of uni- or bi-prediction, and motion vector prediction. In the first step, the reference picture with the minimum non-negative reference index (i.e., non-intra block) is selected from each of reference picture list 0 and reference picture list 1 of the neighboring blocks A, B, and C. If no non-negative reference index exists in reference picture list 0 of the neighboring blocks A, B, and C, and likewise no non-negative reference index exists in reference picture list 1 of the neighboring

g blocks A, B, and C, reference index 0 is selected for both reference picture lists.

The use of uni- or bi-prediction for H.264/AVC spatial direct mode is determined as follows: If a minimum non-negative reference index for both reference picture lists was found in the reference index determination step, bi-prediction is used. If a minimum non-negative reference index for either but not both of reference picture list 0 or reference picture list 1 was found in the reference index determination step, uni-prediction from either reference picture list 0 or reference picture list 1, respectively, is used.

In the motion vector prediction for H.264/AVC spatial direct mode, certain conditions, such as whether a negative reference index was concluded in the first step, are checked and, if fulfilled, a zero motion vector is determined. Otherwise, the motion vector predictor is derived similarly to the motion vector predictor of P blocks using the motion vectors of spatially adjacent blocks A, B, and C.

No motion vector differences or reference indices are present in the bitstream for a direct mode block, while quantized prediction error signal may be coded and present therefore present in the bitstream.

A B_skip macroblock mode is similar to the direct mode but no prediction error signal is coded and included in the bitstream.

Many video encoders utilize the Lagrangian cost function to find rate-distortion optimal coding modes, for example the desired macroblock mode and associated motion vectors. This type of cost function uses a weighting factor or λ to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

The Multiview Video Coding (MVC) extension of H.264 referred above enables to implement a multiview functionality at the decoder, thereby allowing the development of three-dimensional (3D) multiview applications. Next, for better understanding the embodiments of the invention, some aspects of 3D multiview applications and the concepts of depth and disparity information closely related thereto are described briefly.

Stereoscopic video content consists of pairs of offset images that are shown separately to the left and right eye of the viewer. These offset images are captured with a specific stereoscopic camera setup and it assumes a particular stereo baseline distance between cameras.

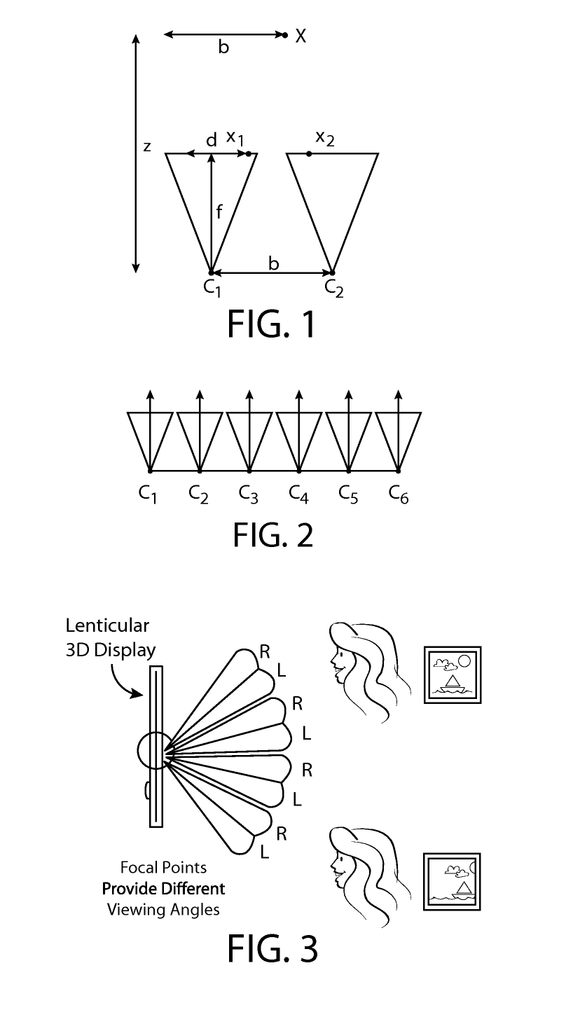

FIG. 1 shows a simplified 2D model of such stereoscopic camera setup. In FIG. 1, C1 and C2 refer to cameras of the stereoscopic camera setup, more particularly to the center locations of the cameras, b is the distance between the centers of the two cameras (i.e. the stereo baseline), f is the focal length of cameras and X is an object in the real 3D scene that is being captured. The real world object X is projected to different locations in images captured by the cameras C1 and C2, these locations being x1 and x2 respectively. The horizontal distance between x1 and x2 in absolute coordinates of the image is called disparity. The images that are captured by the camera setup are called stereoscopic images, and the disparity presented in these images creates or enhances the illusion of depth. For enabling the images to be shown separately to the left and right eye of the viewer, typically specific 3D glasses are required to be used by the viewer. Adaptation of the disparity is a key feature for adjusting the stereoscopic video content to be comfortably viewable on various displays.

However, disparity adaptation is not a straightforward process. It requires either having additional camera views with different baseline distance (i.e., b is variable) or rendering of virtual camera views which were not available in real world. FIG. 2 shows a simplified model of such multiview camera setup that suits to this solution. This setup is able to provide stereoscopic video content captured with several discrete values for stereoscopic baseline and thus allow stereoscopic display to select a pair of cameras that suits to the viewing conditions.

A more advanced approach for 3D vision is having a multiview autostereoscopic display (ASD) that does not require glasses. The ASD emits more than one view at a time but the emitting is localized in the space in such a way that a viewer sees only a stereo pair from a specific viewpoint, as illustrated in FIG. 3, wherein the boat is seen in the middle of the view when looked at the right-most viewpoint. Moreover, the viewer is able see another stereo pair from a different viewpoint, e.g. in FIG. 3 the boat is seen at the right border of the view when looked at the left-most viewpoint. Thus, motion parallax viewing is supported if consecutive views are stereo pairs and they are arranged properly. The ASD technologies may be capable of showing for example 52 or more different images at the same time, of which only a stereo pair is visible from a specific viewpoint. This supports multiuser 3D vision without glasses, for example in a living room environment.

The above-described stereoscopic and ASD applications require multiview video to be available at the display. The MVC extension of H.264/AVC video coding standard allows the multiview functionality at the decoder side. The base view of MVC bitstreams can be decoded by any H.264/AVC decoder, which facilitates introduction of stereoscopic and multiview content into existing services. MVC allows inter-view prediction, which can result into significant bitrate saving compared to independent coding of all views, depending on how correlated the adjacent views are. However, the rate of MVC coded video is proportional to the number of views. Considering that ASD may require 52 views, for example, as input, the total bitrate for such number of views will challenge the constraints of the available bandwidth.

Consequently, it has been found that a more feasible solution for such multiview application is to have a limited number of input views, e.g. a mono or a stereo view plus some supplementary data, and to render (i.e. synthesize) all required views locally at the decoder side. From several available technologies for view rendering, depth image-based rendering (DIBR) has shown to be a competitive alternative.

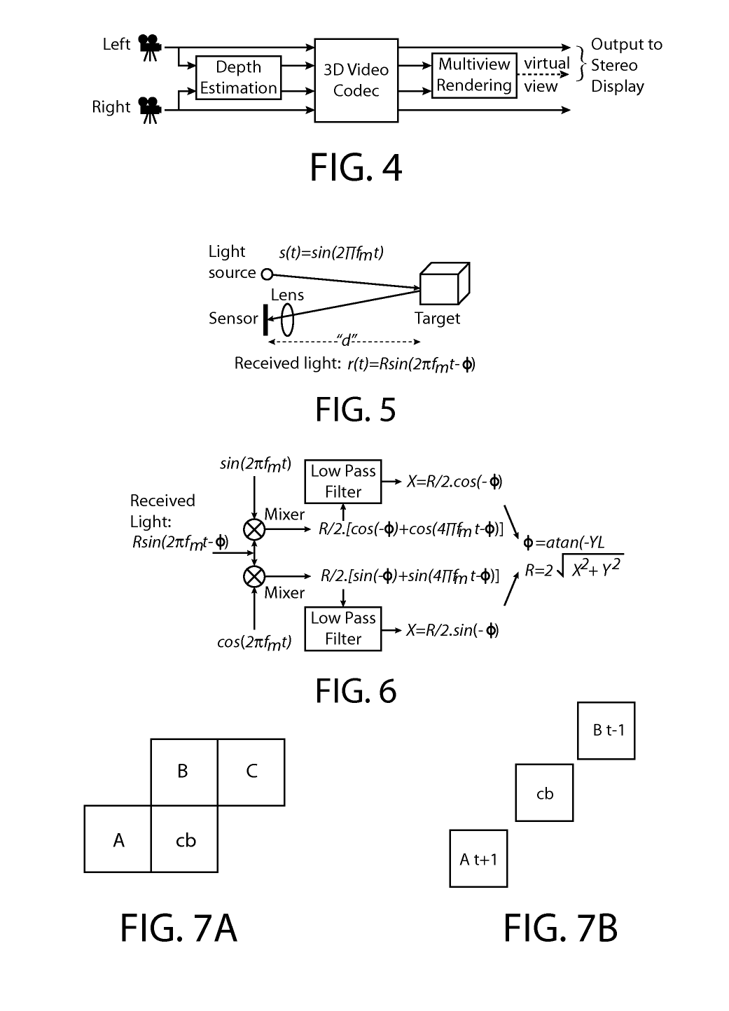

A simplified model of a DIBR-based 3DV system is shown in FIG. 4. The input of a 3D video codec comprises a stereoscopic video and corresponding depth information with stereoscopic baseline b0. Then the 3D video codec synthesizes a number of virtual views between two input views with baseline (bi<b0). DIBR algorithms may also enable extrapolation of views that are outside the two input views and not in between them. Similarly, DIBR algorithms may enable view synthesis from a single view of texture and the respective depth view. However, in order to enable DIBR-based multiview rendering, texture data should be available at the decoder side along with the corresponding depth data.

In such 3DV system, depth information is produced at the encoder side in a form of depth pictures (also known as depth maps) for each video frame. A depth map is an image with per-pixel depth information. Each sample in a depth map represents the distance of the respective texture sample from the plane on which the camera lies. In other words, if the z axis is along the shooting axis of the cameras (and hence orthogonal to the plane on which the cameras lie), a sample in a depth map represents the value on the z axis.

Depth information can be obtained by various means. For example, depth of the 3D scene may be computed from the disparity registered by capturing cameras. A depth estimation algorithm takes a stereoscopic view as an input and computes local disparities between the two offset images of the view. Each image is processed pixel by pixel in overlapping blocks, and for each block of pixels a horizontally localized search for a matching block in the offset image is performed. Once a pixel-wise disparity is computed, the corresponding depth value z is calculated by equation (1):

$$z = \frac{f \cdot b}{D + Δ d} , \qquad ( 1 )$$

where f is the focal length of the camera and b is the baseline distance between cameras, as shown in FIG. 1. Further, D refers to the disparity observed between the two cameras, and the camera offset Δd reflects a possible horizontal misplacement of the optical centers of the two cameras. However, since the algorithm is based on block matching, the quality of a depth-through-disparity estimation is content dependent and very often not accurate. For example, no straightforward solution for depth estimation is possible for image fragments that are featuring very smooth areas with no textures or large level of noise.

Alternatively, or in addition to the above-described stereo view depth estimation, the depth value may be obtained using the time-of-flight (TOF) principle. FIGS. 5 and 6 show an example of a TOF-based depth estimation system. The camera is provided with a light source, for example an infrared emitter, for illuminating the scene. Such an illuminator is arranged to produce an intensity modulated electromagnetic emission for a frequency between 10-100 MHz, which typically requires LEDs or laser diodes to be used. Infrared light is typically used to make the illumination unobtrusive. The light reflected from objects in the scene is detected by an image sensor, which is modulated synchronously at the same frequency as the illuminator. The image sensor is provided with optics; a lens gathering the reflected light and an optical bandpass filter for passing only the light with the same wavelength as the illuminator, thus helping to suppress background light. The image sensor measures for each pixel the time the light has taken to travel from the illuminator to the object and back. The distance to the object is represented as a phase shift in the illumination modulation, which can be determined from the sampled data simultaneously for each pixel in the scene.

In contrast to the stereo view depth estimation, the accuracy of the TOF-based depth estimation is mostly content independent. For example, it is not suffering from the lack of textural appearance in the content. However, currently available TOF cameras have low pixel resolution sensors and the depth estimation is heavily influenced by random and systematic noise.

Disparity or parallax maps, such as parallax maps specified in ISO/IEC International Standard 23002-3, may be processed similarly to depth maps. Depth and disparity have a straightforward correspondence and they can be computed from each other through mathematical equation.

The 3DV systems described above, such as in DIBR-based 3DV systems, typically use mixed-direction motion-compensated prediction including inter-view and/or view synthesis prediction. However, the motion vector prediction specified in H.264/AVC/MVC may be suboptimal for video coding systems utilizing inter-view and/or view synthesis prediction (VSP).

Now in order to improve motion vector prediction (MVP) for the purposes of multi-view coding (MVC), depth-enhanced video coding, multiview+depth (MVD) coding and multi-view with in-loop view synthesis (MVC-VSP), a set of new MVP mechanisms based on utilization of the depth or disparity information (Di) associated with coded texture data are provided herein.

FIG. 14 illustrates the association of depth/disparity blocks d(cb), d(S), d(T), and d(U) with the texture blocks cb, S, T, and U respectively. In various embodiments a depth/disparity block for or associated with a texture block co-locates with the texture block. In other words, the spatial location of the depth/disparity block in relation to the depth/disparity frame it resides is the same as the spatial location of the respective texture block in relation to the depth/disparity frame it resides. In various embodiments, the spatial extents, i.e. the number of samples, may differ in the depth/disparity frame compared to those of the luma texture frame. In order to derive an association between a depth/disparity block and a texture block, the location of the blocks may be normalized as if both frames had the same spatial extents for example through scaling the coordinates of the block and/or resampling of one or both of the frames. In general the association of a depth/disparity block and a respective texture block may also be derived through other criterion than spatial co-location.

It is assumed that the depth or disparity information (Di) for a current block (cb) or for previously coded/decoded texture data is available through decoding of coded depth or disparity information or can be estimated at the decoder side prior to decoding of the current texture block, and this information can be utilized in MVP.

An image fragment or a 2D fragment or a 2D fragment of an image is defined as a subset of an image. An image fragment is typically, but needs not be, rectangular in shape. A video fragment is defined as a subset of a video. A video fragment may be a temporal video fragment, consisting of a subset of the frames or pictures of a single-view video sequence. A video fragment may be a spatio-temporal video fragment consisting of image fragments in a subset of the frames or picture of a single-view video sequence. A video fragment may be a multiview video fragment consisting of frames/pictures or image fragments from different views of a single access unit (i.e. sampling instant) of a multiview video sequence. Other combinations are also possible to form a video fragment, such as spatio-temporal multiview video fragment.

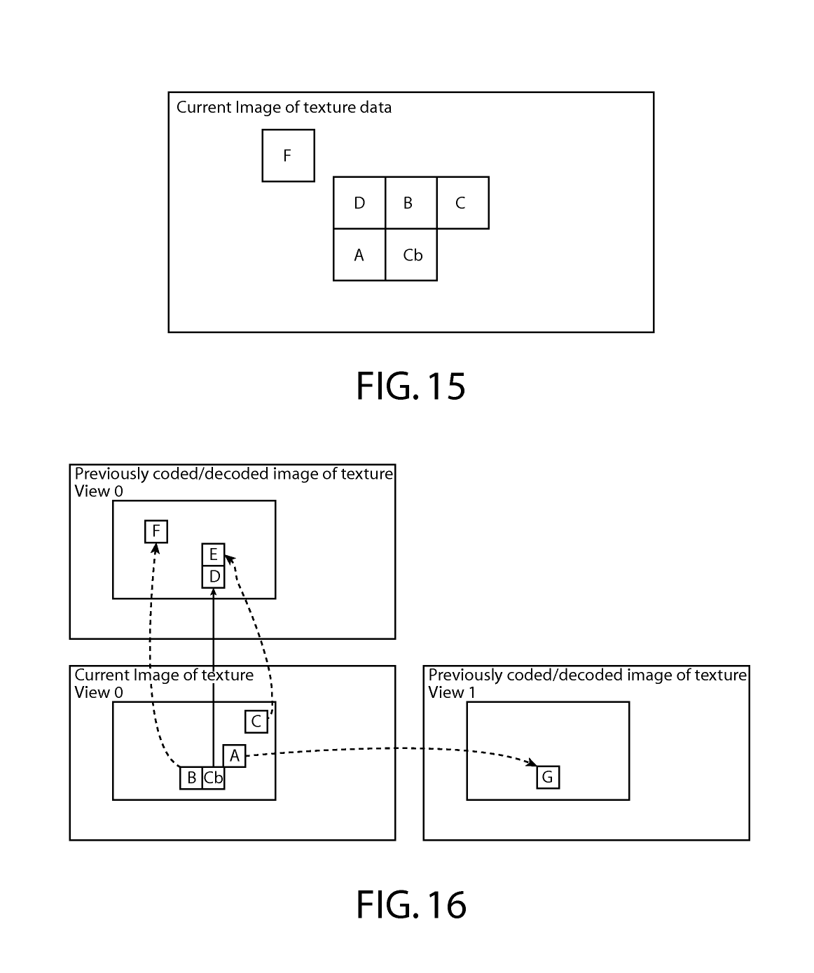

FIG. 15 shows a currently coded/decoded image of texture data, currently coded block cb of texture data, and a fragment of the image (shown in grey) of texture data which is spatially adjacent or located in proximity of cb and which is assumed to be available (decoded) prior to coding/decoding of cb block. 2D blocks of texture data, called “adjacent blocks” A, B, C, D, and F shown as white blocks, and which are assumed to be available (decoded) prior to coding/decoding of cb can utilized by MVP process for coding/decoding of texture block cb. It is noted that blocks A, B, C, D, and F in FIG. 15 are merely examples of selection of adjacent blocks and other blocks may have been selected as well and/or alternatively.

In mathematics, a Euclidean vector may be represented by a line segment having a definite direction and connecting an initial point with a terminal point. Motion information (e.g. horizontal and vertical motion vector components mv_x and mv_y and a reference index) is usually applied to a block position for which the motion information is included in the bitstream. For example, the motion information for block cb, MV(cb), in the bitstream is usually applied to obtain a prediction block by setting the initial point of the motion vector to the spatial location of cb. This prediction block is denoted (cb,MV(cb)). If motion information for block M is applied for motion-compensated prediction at the location of block N, the prediction block is denoted (N,MV(M)).

FIG. 16 shows a concept of adjacent blocks of texture data which is extended to video and multiview video applications. A currently coded image of texture data cb is shown in dark grey block, adjacent image fragments (shown in light grey of several images of texture data) are assumed to be available (coded/decoded) prior to coding of cb block. Note, that adjacent image fragments may belong to previously coded/decoded images of the same view (2D video coding), or may belong to previously coded images of another view (multiview video coding). Correspondence between cb and adjacent blocks may be established in different ways, below are just few examples of such. Texture blocks A and B are spatial neighbors of the cb in currently coded image, texture block D is located in the previously coded/decoded image at the same spatial coordinates (x,y) as cb, whereas texture blocks E, F and G which are located at different images are associated with blocks A, B, C through their motion information MV(A), MV(B) and MV(C) respectively. In other words, block E may be equal to (cb,MV(C)), block F may be equal to (cb,MV(B)), and block G may be equal to (cb,MV(A)). In other embodiments, block E may be equal to (C,MV(C)), block F may be equal to mcp(B,MV(B)), and block G may be equal to (A,MV(A)).

In many embodiments the coding order of texture and depth view components with an access unit is such that the texture and depth view components of the base view are coded first in any order. Then, the depth view component of a non-base view is coded before the texture view component of the same non-base view. The depth view components are coded in their inter-view dependency order, and the texture view components are likewise coded in their inter-view dependency order. For example, there may be three texture and depth views (T0, T1, T2, D0, D1, D2) where the inter-view dependency order is 0, 1, 2 (0 is the base view, 1 is a non-base which may be inter-view predicted from view 0, and 2 is a non-base view which may be inter-view predicted from views 0 and 1). These three texture and depth views may be coded for example in order T0 D0 D1 T1 D2 T2 or D0 D1 D2 TO T1 T2 or D0 T0 D1 T1 D2 T2. The bitstream order of the coded view components may be the same as their coding order, and likewise the decoding order of the coded view components may be the same as the bitstream order. The inter-view dependency order of depth is typically, but needs not be, the same as the inter-view dependency order for texture. The number of depth views may differ from that of texture views. For example, no depth view may be coded for a texture view from which no other texture view is predicted. Slices of depth view components may be differentiated from slices of texture view components for example using a different NAL unit type value.

In some embodiments the coding/decoding order of texture and depth may be interleaved using smaller units than view components, such as on block or slice basis. The respective coding/decoding order of coded texture and depth units, such as blocks, may follow the ordering rules described in the previous paragraph. For example, there may be two spatially adjacent texture blocks, ta and tb, where tb follows ta in coding/decoding order, and two depth/disparity blocks, da and db, spatially co-located with ta and tb, respectively. When prediction parameters for ta and tb are derived with the assistance of da and db, respectively, the coding/decoding order of the blocks may be (da, ta, db, tb) or (da, db, ta, tb). The bitstream order of the blocks may be the same as their coding order.

In some embodiments the coding/decoding order of texture and depth may be interleaved using greater units than view components, such as group of pictures or coded video sequences.

In the following, some parameters relating to many embodiments are described.

### Disparity Estimation

It is assumed herein that the based depth or disparity information associated with currently coded block of texture data is utilized in MVP decisions, and therefore it is assumed that the depth or disparity information is available at the decoder side in advance. In some MVD systems, the texture data (2D video) is coded and transmitted along with pixel-wise depth map or disparity information. Thus, a coded block of texture data (cb_t) can be pixel-wise associated with a block of depth/disparity data (cb_d). The latter can be utilized in the proposed MVP chains without modifications.

In some embodiments, instead of the depth map data the actual disparity information or at least an estimate of it may be required. Thus, a conversion from the depth map data to disparity information may be required. The conversion may be performed as following:

$$Z = 1 / ( \frac{d}{255} ( \frac{1}{{z}_{near}} - \frac{1}{{z}_{far}} ) + \frac{1}{{z}_{far}} ) \\ D = \frac{f \cdot b}{z} ; \qquad ( 2 )$$

where d is a depth map value, z is the actual depth value, and D is the resulting disparity. The parameters f, b, Zₙₑₐᵣ and Z_{far} derived from the camera setup; i.e. the used focal length (f), camera separation (b) and depth range (Zₙₑₐᵣ,Z_{far}) respectively.

According to an embodiment, the disparity information may be estimated from the available textures at the encoder/decoder sides through a block matching procedure or any other means.

Depth and/or Disparity Parameters of a Block

The pixels of a coded block of texture (cb_t) can be associated with a block of depth information (cb_d) for each of said pixels. The depth/disparity information can be aggregatively presented through average depth/disparity values for cb_d and deviation (e.g. variance) of cb_d. The average Av(cb_d) depth/disparity value for a block of depth information cb_d is computed as:

Av(cb_{—}d)=sum(cb_{—}d(x,y))/num_pixels, (3)

where x and y are coordinates of the pixels in cb_d, and num_pixels is number of pixels within cb_d, and function sum adds up all the sample/pixel values in the given block, i.e. function sum(block(x,y)) computes a sum of samples values within the given block for all values of x and y corresponding to the horizontal and vertical extents of the block.
The deviation Dev(cb_d) of the depth/disparity values within a block of depth information cb_d can be computed as:

Dev(cb_{—}d)=sum(abs(cb_{—}d(x,y)−Av(cb_{—}d)))/num_pixels (4)

where function abs returns the absolute value of the value given as input. For determining those coded blocks of texture, which are associated with homogenous depth information, an application-specific predefined threshold T1 can be defined such that:

If Dev(cb_{—}d)=<T1,cb_{—}d=homogenous data (5)
In other words, if the deviation of the depth/disparity values within a block of depth information cb_d is less than or equal than the threshold T1, such cb_d block can be considered as homogenous.
The coded block of texture data cb can be compared to its neighboring blocks nb through their depth/disparity information. The selection of the neighboring block nb may be determined for example based on the coding mode of cb. The average deviation (difference) between the current coded depth/disparity block (cb_d) and each of its neighboring depth/disparity blocks (nb_d) can be computed as:

nsad(cb_{—}d&nb_{—}d)=sum(abs(cb_{—}d(x,y)−nb_{—}d(x,y)))/num_pixels. (6)

where x and y are coordinates of the pixels in cb_d, and in its neighboring depth/disparity block (nb_d), num_pixels is number of pixels within cb_d and functions sum and abs are defined above. Equation (6) may also be regarded as a sum of absolute differences (SAD) between the given blocks normalized by the number of pixels in the block.

In various embodiments, the similarity of two depth/disparity blocks is compared. The similarity may be compared for example using equation (6) but any other similarity or distortion metric may also be used. For example, a sum of squared differences (SSD) normalized by the number of pixels may be used as computed in equation (7):

nsse(cb_{—}d,nb_{—}d)=sum((cb_{—}d(x,y)−nb_{—}d(x,y))̂2)/numpixels (7)

where x and y are coordinates of the pixels in cb_d and in its neighboring depth/disparity block (nb_d), num_pixels is number of pixels within cb_d, notation ̂2 indicates a power of two, and function sum is defined above.

In another example, a sum of transformed differences (SATD) may be used as a similarity or distortion metric. Both the current depth/disparity block cb_d and a neighboring depth/disparity block nb_d are transformed using for example DCT or a variant thereof, herein marked as function T( ). Let tcb_d be equal to T(cb_d) and tnb_d be equal to T(nb_d). Then, either the sum of absolute or squared differences is calculated and may be normalized by the number of pixels/samples, num_pixels, in cb_d or nb_d, which is also equal to the number of transform coefficients in tcb_d or tnb_d. In equation (8), the version of sum of transformed differences using sum of absolute differences is given:

nsatd(cb_{—}d,nb_{—}d)=sum(abs(tcb_{—}d(x,y)−tnb_{—}d(x,y)))/num_pixels (8)

Other distortion metrics, such as the structural similarity index (SSIM), may also be used.
Function diff(cb_d, nb_d) may be defined as follows to enable access any similarity or distortion metric:

diff(cb_{—}d,nb_{—}d)=

nsad(cb_{—}d,nb_{—}d), if sum of absolute differences is used

nsse(cb_{—}d,nb_{—}d), if sum of squared differences is used

nsatd(cb_{—}d,nb_{—}d), if sum of transformed absolute differences is used (9)

Any similarity/distortion metric could be added to the definition of function diff in equation (9). In some embodiments, the used similarity/distortion metric is pre-defined and therefore stays the same in both the encoder and the decoder. In some embodiments, the used similarity/distortion metric is determined by the encoder, for example using rate-distortion optimization, and encoded in the bitstream as an indication. The indication of the used similarity/distortion metric may be included for example in a sequence parameter set, a picture parameter set, a slice parameter set, a picture header, a slice header, within a macroblock syntax structure, or anything alike. In some embodiments, the indicated similarity/distortion metric may be used in pre-determined operations in both the encoding and the decoding loop, such as depth/disparity based motion vector prediction. In some embodiments, the decoding processes for which the indicated similarity/distortion metric is indicated are also indicated in the bitstream for example in a sequence parameter set, a picture parameter set, a slice parameter set, a picture header, a slice header, within a macroblock syntax structure, or anything alike. In some embodiments, it is possible to have more than one pair of indications for the depth/disparity metric and the decoding processes the metric is applied to in a the bitstream having the same persistence for the decoding process, i.e. applicable to decoding of the same access units. The encoder may select which similarity/distortion metric is used for each particular decoding process where a similarity/distortion based selection or other processing is used, such as depth/disparity based motion vector prediction, and encode respective indications of the selected disparity/distortion metrics and to which decoding processes they apply to into the bitstream.

When the similarity of disparity blocks is compared, the viewpoints of the blocks are typically normalized, e.g. so that the disparity values are scaled to result from the same camera separation in both compared blocks.

There is provided the following elements which can be combined into a single solution, as will be described below, or they can be utilized separately. As explained earlier, both a video encoder and a video decoder typically apply a prediction mechanism, hence the followings elements may apply similarly to both a video encoder and a video decoder.
1. Selection of reference index and candidate motion vectors for MVP of skip and/or direct modes
For the P_Skip mode of H.264/AVC, the reference picture of a macroblock coded with the P_Skip type has index 0 in reference picture list 0. Such reference index selection equal to 0 is herein referred to as a “zero-value” reference index prediction.
The reference index(es) for a direct mode block and for a B_skip block in H.264/AVC are selected based on the minimal available non-negative reference index in the neighboring blocks.
According to an embodiment, instead of reference index selection such as in H.264/AVC, the reference index(es) for skip and/or direct modes and/or alike may be selected based on the similarity of the depth/disparity of the current block and the depth/disparity of neighboring blocks. For example, the reference index of the neighboring block that has the smallest depth/disparity deviation compared to the current block may be selected as the reference index of the current block.
According to an embodiment, in skip and/or direct modes and/or alike, the directional and/or median motion vector prediction and/or alike is applied only among the motion vectors of those neighboring blocks that have the same reference index as the current block or additionally have sufficient depth/disparity similarity compared to the depth/disparity of the current block.
2. Disparity-compensated default motion vector predictor
For each cb block that utilizes inter-view prediction, i.e. uses a reference index that points to an inter-view (only) reference picture and for which no motion vector for block A, B, and C is available for MVP, the motion vector predictor is set according to the disparity information of the current block of texture data Di(cb).
Whenever no motion vector predictor is available and the reference index points to an inter-view reference picture or an inter-view only reference picture, the motion vector predictor is set to a value derived from Di(cb), such as the average disparity derived over all samples of Di(cb). In H.264/AVC, the situation that no motion vector for blocks A, B, and C is available leads to the use of a motion vector equal to 0 (and a reference picture having reference index 0 in spatial direct mode), herein referred to as the use of “zero-value default”. The replacement of “zero-value default” motion vector prediction with the disparity-compensated default as described above may be further conditioned to be used only if the deviation or variance of sample values in Di(cb) is below a certain threshold.
3. Disparity-compensated co-located block determination for temporal direct mode and/or alike
In H.264/AVC, a co-located block in reference index 0 in reference picture list 1 is selected as the source for motion vector predictor for a current block cb using temporal direct mode. According to an embodiment, when the prediction direction in a temporal direct mode or any other prediction mode using motion vector prediction from earlier coded/decoded pictures, instead of a spatially co-located block, a disparity-compensated co-located block is selected as a source for motion vector prediction. For example, the disparity information of the current block of texture data Di(cb) may be averaged and quantized to the block grid for motion-compensated prediction to form a disparity motion vector. The disparity motion vector is then used to find a disparity-compensated co-located block, whose motion vector is used as the source for motion vector prediction.
In some embodiments, the depth/disparity information of the disparity-compensated co-located block is compared to the depth/disparity information of the current block. If the depth/disparity information of these two blocks is sufficiently similar, for example if their deviation is below a certain threshold, the motion vector of the disparity-compensated co-located block is used in motion vector prediction of the current block. Otherwise, the motion vector of the disparity-compensated co-located block is not used in motion vector prediction of the current block. The disparity/depth information of these two blocks may differ, for example, when an object covered by current block is occluded by another object in disparity-compensated co-located block.
In some embodiments, a similarity search of depth/disparity information is performed between the depth/disparity of the current block Di(cb) and a selected area in the reference picture. The disparity motion vector may be used as a start position for the similarity search, and only the blocks adjacent to the block where the disparity motion vector may be within the area being searched. The block that results in a smallest value of a distortion or distance measure, such as deviation, compared to Di(cb) is selected as the disparity-compensated co-located block, whose motion vector is used as the source for motion vector prediction of the current block cb.
In some embodiments, a temporal motion vector prediction may be used in a uni-prediction mode, and a disparity-compensated co-located block is selected as a source for motion vector prediction.
4. Applying directional and/or median MVP and/or alike only to neighboring blocks that share the same prediction direction with each other and/or with the current block (cb).
In some embodiments, the MVP classifies neighboring blocks of the current block (cb) with respect to its prediction directions (intra-view, inter-view, VSP), and processes each prediction direction (group of neighboring blocks) independently. Thus, the MVP involves no mixing of temporal, inter-view, or VSP directions in a single decision. Then, if the reference index of the current block (cb) is available, the directional and/or median motion vector prediction is computed according from the neighboring blocks with identical prediction direction (again, no mixing of temporal, inter-view, or VSP directions). In other words, neighboring blocks A, B, and C may be available for motion vector prediction and/or mixed-direction motion-compensated prediction only if they have the same prediction direction as the current block (cb).
5. Selection of motion vector prediction candidates based on depth/disparity similarity Also, a motion vector predictor from the neighboring blocks can be selected based on depth/disparity similarity, such as the minimal (absolute) difference in average (per pixel) depth/disparity, between currently coded block of texture data, and neighboring blocks of texture data. For example, the motion vector of that neighboring block that has the minimal (absolute) difference in average (per pixel) depth/disparity compared to the depth/disparity of cb can be selected as the motion vector predictor for the currently coded or decoded texture block (cb). In another example, all those neighboring blocks nb for which the similarity measure of the disparity/depth block of nb compared to the disparity/depth block of cb is below a threshold value may be selected for the directional and/or median MVP or alike.
6. Selection of uni-prediction/bi-prediction and the reference picture list(s) used for prediction
A number of prediction parameters for the decoding of the currently coded or decoded block (cb) can be determined based on the values associated with the neighboring blocks. For example, the number of reference picture lists used, i.e. the number of prediction blocks used for the currently coded block cb, can be determined based on the number of prediction blocks used in the neighboring block having the greatest depth/disparity similarity, such as the smallest average (absolute) difference in (per pixel) depth/disparity compared to current depth block.
Alternatively or in addition, in direct and/or skip modes and/or alike, the depth/disparity similarity of the current block cb and the prediction block may be used to determine whether uni-prediction or bi-prediction is used, and which reference picture list is used for uni-prediction. In bi-prediction, there are two prediction blocks, which are herein referred to as pb0 and pb1, which originate from a picture in reference picture list 0 and reference picture list 1, respectively. Let the depth/disparity information of pb0 and pb1 be Di(pb0) and Di(pb1), respectively. Di(pb0) is compared to the depth/disparity information of the current block Di(cb). If Di(pb0) is similar to Di(cb), pb0 is used as a prediction block; otherwise, pb0 is not used as a prediction block for the current block. Similarly, if Di(pb1) is similar to Di(cb), pb1 is used as a prediction block; otherwise pb1 is not used as a prediction block for the current block. If both pb0 and pb1 remain as prediction blocks, bi-prediction is used. If pb0 is a prediction block but pb1 is not, uni-prediction from pb0 (i.e. reference picture list 0) is used. Similarly, if pb0 is not a prediction block but pb1 is, uni-prediction from pb1 (i.e. reference picture list 1) is used. If neither pb0 nor pb1 is a prediction block, another coding mode may be inferred, such as bi-predictive mode with motion vector difference coding, or another pair of reference pictures may be selected, for example.
In H.264/AVC, uni-prediction (one reference picture list) or bi-prediction (two reference picture lists) may be used, but generally there may be any number of prediction blocks (so-called multi-hypothesis prediction). Hence, the above-mentioned embodiments may be generalized to more than two prediction hypotheses.
7. Coding mode and prediction direction prediction
In addition, as a further example of determining a prediction parameter for the decoding of the currently coded or decoded block (cb) based on the values associated with the neighboring blocks, the coding mode (e.g. temporal direct, spatial direct, skip) can be determined to be equal to the coding mode of the neighboring block having the greatest depth/disparity similarity, such as the smallest average (absolute) difference in (per pixel) depth/disparity, compared to current depth block.
Further, the prediction direction (intra-view, inter-view, VSP) can be selected based on the greatest depth/disparity similarity, such as the minimal difference in average (per pixel) depth/disparity between currently coded block (cb) of texture, and neighboring blocks of texture. Similarly, the reference index can be selected based on the greatest depth/disparity similarity, such as the minimal difference in average (per pixel) depth/disparity between currently coded blocks, and neighboring blocks of texture.

Many embodiments may be divided into the following ordered steps:
1. The encoder/decoder selects one or more adjacent blocks S, T, U, . . . to the current block cb
2. The encoder/decoder obtains the depth/disparity blocks associated with the one more adjacent blocks d(S), d(T), d(U),
3. The encoder/decoder compares the current depth/disparity block d(cb) to the depth/disparity blocks associated with the one more adjacent blocks d(S), d(T), d(U), using a similarity/distortion metric such as the one presented in equation (9).
4. The encoder/decoder selects one or more of the depth/disparity blocks associated with the one more adjacent blocks d(S), d(T), d(U), . . . on the basis of comparison (e.g. minimizing distortion or maximizing similarity compared to d(cb)).
5. The encoder/decoder derives motion information MVP for cb from the selected depth/disparity blocks d(S), d(T), d(U) associated with the one more adjacent blocksS, T, U, . . . or from the selected adjacent blocks S, T, U, . . . or from the information coded for the selected blocks d(S), d(T), d(U), . . . or the selected blocks S, T, U, . . . .
6. The encoder/decoder encodes/decodes block cb using the motion information MVP. The encoder/decoder may for example use MVP as the reference index and motion vector predictor and encode/decode motion vector difference relative to the MVP; or the encoder/decoder may for example use MVP as the motion vector for cb.

In various embodiments, different methods for selecting adjacent blocks to be used in MVP for cb may be applied. The methods for selecting adjacent blocks to be used in MVP may include but are not limited to the following or any combination of the following:
1. Selecting adjacent blocks that share a boundary with cb and have been coded/decoded prior to cb. A pre-defined algorithm or rule may be used by the encoder and the decoder to select adjacent blocks identically. For example, adjacent blocks may be selected as blocks A, B, C, D, and E of FIG. 13 provided that they are coded/decoded prior to cb.
2. Selecting adjacent blocks from an image fragment also containing cb and has been coded/decoded prior to cb. In some embodiments, the encoder may select adjacent blocks and code information into the bitstream to identify the adjacent blocks, for example as relative coordinates of the adjacent blocks in relation to the position of cb. The encoder may for example use rate-distortion optimization for the selection of adjacent blocks. In some embodiments, the encoder and the decoder may perform motion estimation or block matching for d(cb) within the depth/disparity picture containing d(cb), and each position tested in the block matching may be considered to co-locate with an adjacent block. In some embodiments, the encoder and the decoder may perform motion estimation or block matching for d(cb) within the depth/disparity picture containing d(cb), and the adjacent blocks may be selected to co-locate with the one or more positions having among those having smallest cost in block matching.
3. Selecting adjacent blocks from pictures other than the picture containing cb for example as follows. First, spatially neighboring blocks, such as blocks A, B, C, D, and E of FIG. 13 provided that they are coded/decoded prior to cb, may be selected for example using step 1 or 2 above. Then, the motion vectors of those blocks may be applied in the location of cb to obtain adjacent blocks, e.g. the adjacent block derived from spatially neighboring block A would be (cb,MV(A)). Alternatively or in addition, a motion vector to be used for obtaining adjacent blocks may be derived from more than one motion vector of the selected spatially neighboring blocks. For example, a motion vector MV_{cvm} may be obtained by taking the median of the horizontal components of the motion vectors of the selected spatially neighboring blocks and the media of the vertical components of the motion vectors of the selected spatially neighboring blocks. Then, an adjacent block may be obtained by applying MV_{cvm} in the position of cb, i.e. the adjacent block would be (cb, MV_{cvm}).
4. Selecting adjacent blocks from pictures other than the picture containing cb for example as follows. First, reference pictures for motion estimation may be selected for example based on the reference indexes of the motion vectors of spatially neighboring blocks selected e.g. as described in one or more of steps 1 to 3 above. Second, location of a search window may be selected for example based on the location of adjacent block derived in one ore more of steps 1 to 3 above. Third, the encoder and the decoder may perform motion estimation or block matching for d(cb) within the selected depth/disparity reference pictures and search window. The adjacent blocks may be selected to reside in the texture picture associated with the selected depth/disparity reference picture and co-locate with the one or more positions having among those having smallest cost in block matching.
5. Selecting adjacent blocks by deriving motion information through the associated depth/disparity block d(cb). If needed, the depth/disparity values of d(cb) may be converted to a disparity block d_{ref}(cb) relative to a another view v_{ref}. The average disparity value of d_{ref}(cb), avg(d_{ref}(cb)), may be used as a motion vector pointing to view component v_{ref}. The averaging may also include quantization or rounding for example to the accuracy of motion vectors, such as quarter-pixel position. An adjacent block may be obtained by applying the obtained inter-view motion vector, avg(d_{ref}(cb)), in the position of cb, i.e. the adjacent block would be avg(d_{ref}(cb)).
6. Selecting adjacent blocks by using the motion vectors in the depth/disparity picture containing d(cb) as follows. First, spatially neighboring depth/disparity blocks relative to d(cb), such as those corresponding to A, B, C, D, and E of FIG. 13, may be selected for example using step 1 or 2 above. Alternatively or in addition, the co-located or associated block d(cb) may be selected. The respective motion vectors may be denoted MV(d(A)), MV(d(B)), MV(d(C)), MV(d(D)), MV(d(E)), and MV(d(cb)). Then, an adjacent blocks may be obtained by applying the motion vectors of the selected co-located or spatially neighboring depth/disparity blocks to the position of the cb, for example the adjacent block corresponding to neighboring block A would be (cb,MV(d(A))).

In some embodiments, a motion estimation process, such as block matching, may be performed for the current depth/disparity block d(cb) as follows. The search range may be selected to be within the current depth/disparity picture, i.e. within the picture d(cb) also resides. In some embodiments the search range may additionally or alternatively be selected to be within a different depth/disparity picture, i.e. a picture other than the picture where d(cb) resides. For example, the search range be selected to be within a depth/disparity picture that is associated with the texture picture identified by the reference index of cb. In another example, the search range may be selected to be within a depth/disparity picture that is inferred as a reference picture for direct mode or alike prediction of cb or d(cb).

In some embodiments, the search range may be spatially limited to exclude fragments that are associated with not available blocks (i.e. not coded/decoded yet) in a texture picture containing the current block cb. The search range may be further spatially limited not to exceed a certain an image fragment of a certain size and shape, which is surrounding or being adjacent to d(cb).

A block matching search may be performed within the search range using a certain algorithm. In some embodiments, the encoder indicates the used algorithm and/or parameter values for the used algorithm by encoding one or more indications into the bitstream, and the decoder decodes the one or more indications and performs the block matching search according to the decoded information on the used algorithm and/or parameter values for the used algorithm. A block matching search may for example by done using a full search wherein each block position within the search range is examined. In block matching, a cost is calculated between the source block, d(cb), and each block within the search range that is selected by the block matching algorithm. For example, SAD, SSD, or SATD may be used as a cost in block matching. In some embodiments the block matching algorithm may be limited to search only certain block positions, which may be co-locating with the rectangular grid used to partition the picture.

The block position/positions which minimizes/minimize said cost in block matching, referred to as (x_{bb}, y_{bb}), may be then processed as follows. Motion information MV(xbb) may be derived for the block position (x_{bb}, y_{bb}) e.g. through block d(xbb) having the size and shape of d(cb) and located at (x_{bb}, y_{bb}) within the depth/disparity picture containing the search range and/or through block xbb having the size and shape of d(cb) and located at (x_{bb}, y_{bb}) within the texture picture associated with or correspond to the depth/disparity picture containing the search range, e.g. using one of the following ways or their combination:
If block d(xbb) covers a single block d(bb) for which motion information MV(d(bb)) has been derived and coded/decoded earlier, then MV(xbb) may be selected to be identical to MV(d(bb)).
If block d(xbb) covers more than one block d(bbₙ) when n may be vary from one to the number of such blocks and for which motion information MV(d(bbₙ)) has been derived and coded/decoded earlier, then MV(xbb) may be selected to be derived from MV(d(bbₙ)) for example by first selecting reference index that is used for motion information for most samples within d(xbb) and then taking the median motion vector, the median motion vector components, the average motion vector, the average motion vector components, or the MV(d(bbₙ)) covering an area where the normalized cost is the smallest among all values of n that the selected reference index.
If block xbb covers a single block bb for which motion information MV(bb) has been derived and coded/decoded earlier, then MV(xbb) may be selected to be identical to MV(bb).
   If block xbb covers more than one block bbₙ when n may be vary from one to the number of such blocks and for which motion information MV(bbₙ) has been derived and coded/decoded earlier, then MV(xbb) may be selected to be derived from MV(bbₙ) for example by first selecting reference index that is used for motion information for most samples within xbb and then taking the median motion vector, the median motion vector components, the average motion vector, the average motion vector components, or the MV(bbₙ) covering an area where the normalized cost is the smallest among all values of n that the selected reference index.

In some embodiments, the motion information MV(xbb) may be used for obtaining adjacent blocks for the MVP of cb. In other words, an adjacent block may be obtained by applying MV(xbb) in the location of cb, i.e. the adjacent block may be (cb,MV(xbb))

In some embodiments, the motion information MV(xbb) may be used for prediction of cb. For example, a prediction block for cb may be obtained by applying MV(xbb) in the location of cb, i.e. the prediction block may be (cb,MV(xbb)).

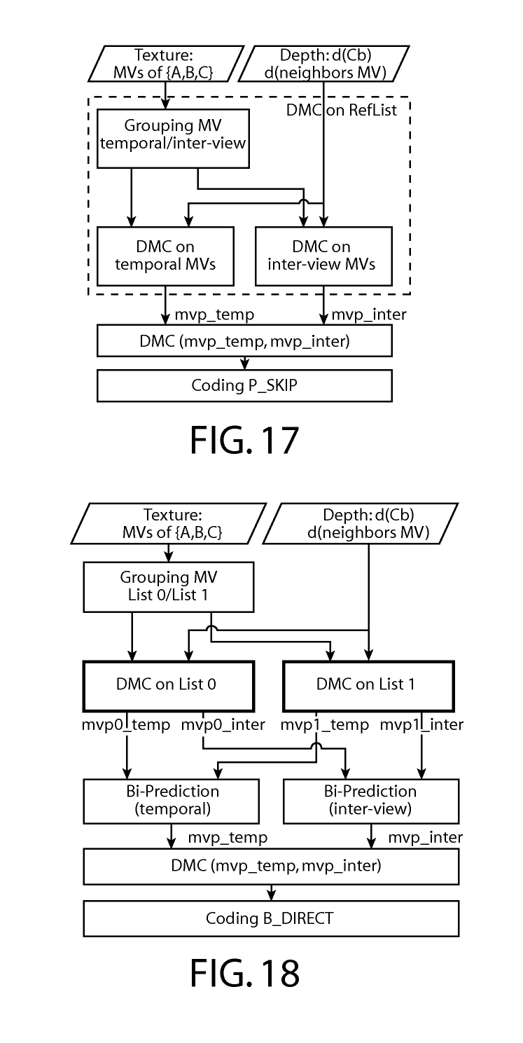

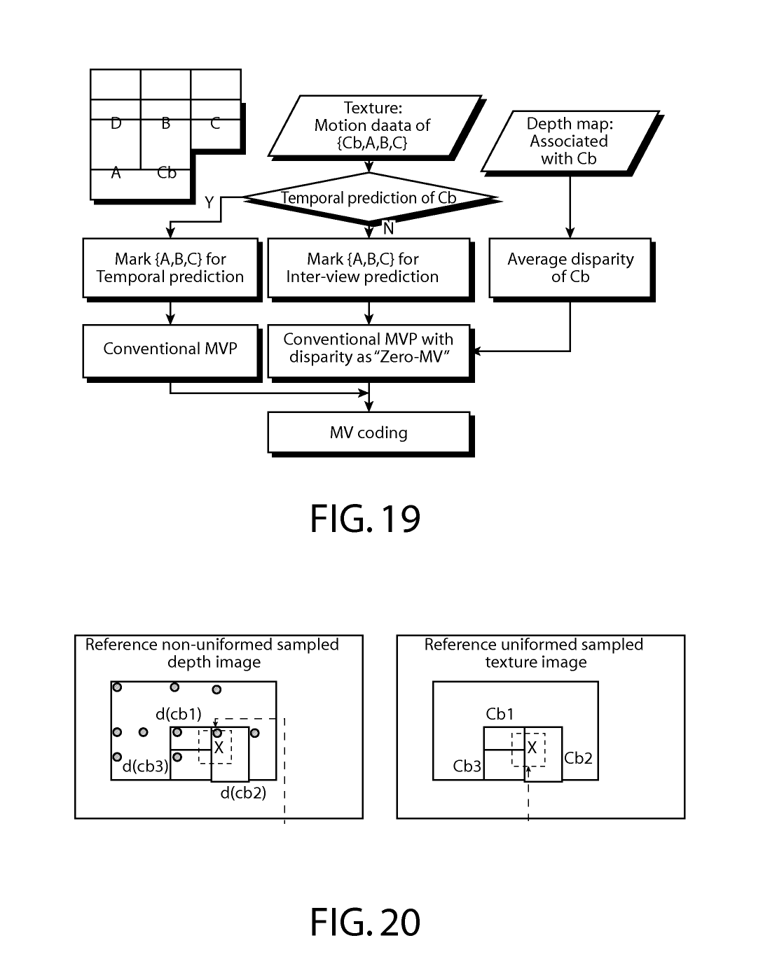

In some embodiments, motion information for the decoding of the currently coded or decoded block (cb) may be determined as follows. Flow charts of the process for the Depth-based Motion Competition (DMC) in the Skip and Direct modes are shown in FIG. 17 and FIG. 18, respectively. In the Skip mode, motion vectors {MVi} of texture data blocks {A, B, C} are grouped according to their prediction direction forming Group 1 and Group 2 for temporal and inter-view, respectively. The DMC process, which is detailed in the grey block of FIG. 17, is performed for each group independently.

For each motion vector MVi within a given Group, a motion-compensated depth block d(cb,MVi) is derived, where the motion vector MVi is applied relative to the position of cb to obtain the depth block from the reference picture pointed to by MVi. Then, the similarity of d(cb) and d(cb,MVi) is estimated as shown in (10):

SAD(MVᵢ)=SAD(d(Cb,MVᵢ),d(Cb)). (10)

The MVi that provides a minimal SAD value within a current Group is selected as an optimal predictor for a particular direction (mvp_{dir})

$${mvp}_{dir} = arg {min}_{{mvp}_{dir}} ( SAD ( {MV}_{i} ) ) \qquad ( 11 )$$

Following this, the predictor in the temporal direction (mvpₜₑₘₚ) is competed against the predictor in the inter-view direction (mvpᵢₙₜₑᵣ). The predictor which provides a minimal SAD is selected for usage in the Skip mode:

$${mvp}_{opt} = arg {min}_{{mvp}_{dir}} ( SAD ( {mvp}_{temp} ) , SAD ( {mvp}_{inter} ) ) \qquad ( 12 )$$

The MVP for the Direct mode of B slices, illustrated in FIG. 18, is similar to the Skip mode, but DMC (marked with grey blocks) is performed over both reference pictures lists (List 0 and List 1) independently. Thus, for each prediction direction (temporal or inter-view) DMC produces two predictors (mvp0dir and mvp1dir) for List 0 and List 1, respectively. The SAD values of mvp0dir and mvp1dir are computed as shown in (10) and averaged to form the SAD of bi-prediction for each direction independently:

SAD(mvp_{dir})=(SAD(mvp0_{dir})+SAD(mvp1_{dir}))/2 (13)

And finally, the MVP for the Direct mode is selected from available mvpᵢₙₜₑᵣ and mvpₜₑₘₚ as it shown in (12).

In yet another embodiment, motion vector prediction scheme can be implemented as follows. All available adjacent to cb blocks (A, . . . E) are classified according to the direction of their prediction (temporal or inter-view). If cb uses an inter-view reference picture, all neighboring blocks which do not utilize inter-view prediction are marked as not-available for MVP and are not considered in the median or directional MVP calculation or alike. Vice versa, if cb uses temporal prediction, neighboring blocks that used inter-view reference frames are marked as not-available for MVP. The flowchart of this process is depicted in FIG. 18. In addition, the “zero-MV” MVP for when inter-view prediction is in use is revised as follows: if no motion vector candidates are available from the neighboring blocks, MVx is set to average disparity D̅(cb) value which is associated with current texture cb and computed as:

D̅(cb)=(1/N)·Σᵢ/D(cb(i)),

where D(cb(i)) is a disparity computed in (2) for pixel cb(i), i pixel index in block cb and N is number of pixels in block cb.

In some embodiments, the inference of all or certain above-mentioned prediction parameters for cb from the neighboring block having the greatest depth/disparity similarity, such as the smallest average (absolute) difference in (per pixel) depth/disparity compared to current depth block may be performed only if a depth/disparity similarity value meets a condition related to a threshold, such as exceeds a threshold. Different thresholds for prediction parameters may also be used.

Herein below some embodiments will be disclosed, wherein the general aspects described above will be combined into a single solution, but it is nonetheless emphasized that each of said aspects can be utilized separately, too.

The above parameters and equations can be used in various embodiments of depth/disparity information based motion vector prediction (MVP) described below.

According to an embodiment, instead of setting the reference frame index of current block always equal to zero or to a value derived from the reference indexes of the neighboring texture blocks in a skip and/or direct mode and/or alike, such as in the P_SKIP mode of H.264/AVC, a modified procedure for determination of a reference index and candidate motion vectors for motion vector prediction for a skip and/or direct mode and/or alike is disclosed herein and referred to as disparity-compensated zero-value prediction mode.

For analyzing, if the current coded block cb comprises homogenous depth information, the average depth/disparity value for a block of depth information Av(cb_d) and the deviation of the depth/disparity values within a block of depth information Dev(cb_d) may be computed according to equations (3) and (4). Then if the deviation of the depth/disparity values within a block of depth information cb_d is less than or equal than the threshold T1 according to equation (5), the current coded block cb may be considered as homogenous.

Then, based on the average depth/disparity value for a block of depth information Av(cb_d), a disparity value d(cb), which is common for the whole coded block cb, may be calculated according to equation (2). The resulting disparity value d(cb) may be then used as motion vector predictor and the reference index may be inferred to be equal to the reference index of the inter-view reference picture or inter-view only reference picture for which the disparity applies. However, if it was noted in connection with equation (5) that the depth information of the current coded block cb is not homogenous, then the zero-value prediction as disclosed in the current H.264/AVC MVP may be used; e.g. in the P_Skip mode of H.264/AVC the median motion vector prediction is applied and the reference index is set to 0.

According to an embodiment, similarities in the depth/disparity information of the current coded block (cb) and each of its neighboring blocks (nb) are used as a basis for determining one or more parameters for the motion vector prediction of the current coded block (cb). First, the average deviation between the current coded block cb and each of its neighboring blocks nb(A, B, C, . . . ) is computed according to equation (9). From the resulting deviation values, a minimum value min(diff(cb, nb)) is searched. If the minimum value min(diff(cb, nb)) is less or equal to a threshold T2 (i.e. if min(diff(cb, nb))=<T2), it indicates that the neighboring block having the minimum difference to the current coded block is sufficiently similar to the current coded block. Consequently, the neighboring block having the minimum difference to the current coded block is selected as a source of MVP parameters, and one or more parameters for the motion vector prediction are copied from said neighboring block to be used in the motion vector prediction of the current block.

According to an embodiment, if no sufficiently similar neighboring block is found (i.e. if min(diff(cb, nb))>T2), then a depth/disparity based neighbor pre-selection process can be used for the motion vector prediction. As a first step, the neighboring blocks are grouped together according to their prediction direction. Accordingly, three possible groups of blocks (Gx) are available: G1: Temporally predicted blocks (intra-view prediction), G2: Inter-view prediction block, and G3: VSP prediction blocks.

For all groups presently available, the average deviation (difference) between the current coded block (cb) and each group of blocks (Gx) is computed according to equation (9).

From the resulting deviation values, the group (Gmin) which provides a minimum value min(diff(cb, Gx)) is searched. If the minimum value min(diff(cb, Gx)) of said group Gmin is less or equal to a threshold T3 (i.e. if min(diff(cb, Gx))=<T3), the blocks within said group are marked as available for motion vector prediction and/or mixed-direction motion-compensated prediction and the rest of blocks are marked as unavailable for motion vector prediction and/or mixed-direction motion-compensated prediction. Then motion vector prediction, such as directional and/or median motion vector prediction, is performed for the current coded block from neighboring blocks, which belong to the group Gmin. However, if the minimum value min(diff(cb, Gx)) of said group Gmin exceeds the threshold T3 (i.e. if min(diff(cb, Gx))>T3), then the above embodiment of the disparity-compensated zero-value prediction mode could be used.

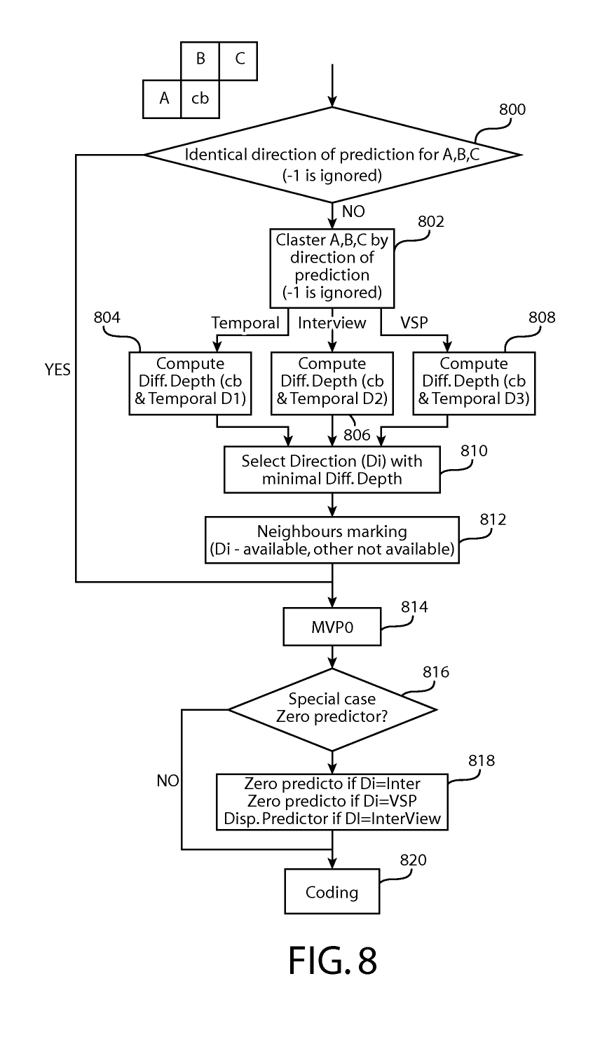

The last embodiment can be illustrated by the flow chart of FIG. 8, wherein spatially neighboring blocks A, B and C are available for the motion vector prediction of the current block cb. If no identical prediction direction for the blocks A, B and C can be found (800), then the blocks A, B and C are grouped (802) according to their prediction direction to three possible groups, and for all groups presently available, the average deviation between the current coded block and each group of blocks is computed (804, 806, 808). The prediction direction group providing the minimum value min(diff(cb, Gx)) is selected (810) as the prediction direction. Then the blocks within said group are marked (812) as available for motion vector prediction and/or mixed-direction motion-compensated prediction and the rest of blocks are marked as unavailable for motion vector prediction and/or mixed-direction motion-compensated prediction. After that motion vector prediction (MVPO), such as directional and/or median motion vector prediction of H.264/AVC, is performed (814) for the current coded block from neighboring blocks, which belong to the said group. If a skip or direct mode or alike is used for the current block and it is concluded (816) that a conventional motion vector prediction process, such as H.264/AVC MVP, would use a “zero-value” reference index and/or a “zero-value default” motion vector predictor, then the reference index and motion vector predictor are selected in 818 as follows. If a conventional motion vector prediction process would use a “zero-value” reference index, the reference index is instead selected to refer to a reference picture having the smallest reference index and having the same prediction direction as the selected prediction direction group. If the selected prediction direction is inter-view prediction and a “zero-value default” motion vector predictor is concluded, then the disparity value d(cb) according to equation (2) is used instead of a “zero-value” motion vector predictor in coding or decoding process (820). Otherwise, the “zero-value default” motion vector predictor, for example as disclosed in the current H.264/AVC MVP is be used.

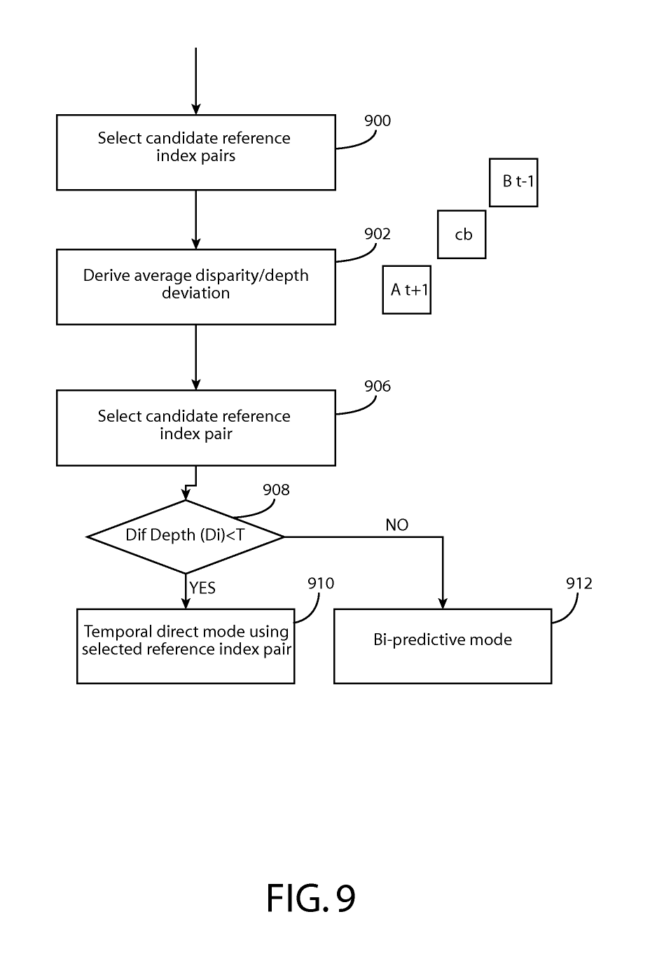

The flow chart of FIG. 9 illustrates an embodiment for a temporal direct mode or alike. First, in 900, the candidate reference index pairs to be used for the current cb are determined as follows. The reference index variable for list 1 cri is first set to 0. The co-located block A resides in a reference picture having the reference index cri in reference picture list 1. If the prediction direction of block A is inter-view, the selection of block A may be disparity compensated as described earlier. The co-located block A uses mixed-direction motion-compensated prediction from block B from a reference picture that is present in reference picture list 0. If the prediction direction of block A is intra-view and the reference pictures containing block A and block B in the same view as the picture containing cb, block A and B are considered available and the respective reference indexes are included as a candidate reference index pair. If the prediction direction of block A is inter-view and the reference pictures containing block A and block B are in different views (but the same access unit) as the picture containing cb, block A and B are considered available and the respective reference indexes are included as a candidate reference index pair. Otherwise, block A and B are considered not available. Then, cri is incremented by 1 and the steps above are repeated, unless cri refers to a reference index that is not available in reference picture list 1. If no there is no candidate reference index pair at the end of the process of 900, then for example the reference index selection for temporal direct mode of H.264/AVC may be applied.

In 902, the average depth/disparity deviation between the current block cb and blocks A and B of each candidate reference index pair may be computed according to equation (9).

From the resulting deviation values, the candidate reference index pair with a minimum value min(diff(cb, nb)) may be selected (906). If the minimum value of the selected reference index pair min(diff(cb, nb)) is less than or equal to a threshold T (908), then temporal direct prediction or alike is applied for cb (910). In some embodiments steps 902, 906, and 908 may be omitted and temporal direct mode prediction or alike may be performed using the first candidate reference index pair found in 900. If the prediction direction is inter-view, camera index differences, camera translation vectors, camera separations, or alike may be used in the temporal direct mode or alike for scaling the motion vector from the co-located block when using it for deriving a motion vector predictor for the current block cb.

If the minimum value of the selected reference index pair min(diff(cb, nb)) is greater than a threshold T4 (908), another prediction mode such as conventional bi-prediction may be inferred (912).

In various embodiments presented above neighboring blocks to the current block being coded/decoded cb are selected. Examples of selecting neighboring blocks include spatial neighbors (e.g. as indicated in FIG. 7a) or temporal co-located neighbors as determined for example by the reference index selection of a temporal direct mode or alike (e.g. as indicated in FIG. 7b). Other examples include disparity-compensated neighbors in adjacent views whereby disparity compensation may be applied to determine correspondence of a neighboring block to cb. The aspects of the invention are not limited to the mentioned methods of selecting neighboring blocks, but rather the description is given for one possible basis on top of which other embodiments of the invention may be partly or fully realized.

In some embodiments, the encoder may determine the value of any of the above-mentioned thresholds for example based on encoding blocks with different values of the threshold and selecting the value of the threshold that is optimal according to the Lagrangian rate-distortion optimization equation. The encoder may indicate the determined value of the threshold within the bitstream, for example by encoding it as a syntax element for example in a sequence parameter set, a picture parameter set, a slice parameter set, a picture header, a slice header, within a macroblock syntax structure, or anything alike. in some embodiments, the decoder determines the threshold based on the information encoded in the bistream, such as a codeword indicating the value of threshold.

In some embodiments, the encoder performs optimization, such as rate-distortion optimization, jointly when selecting values of syntax elements for the current texture block cb and the co-located current depth/disparity block Di(cb). In a joint rate-distortion optimization, the encoder may for example encoder cb and Di(cb) in multiple modes and select the pair of modes that results into the best rate-distortion performance among the tested modes. For example, it may happen that a skip mode would be optimal in rate-distortion performance for Di(cb), but when the rate-distortion performance of cb and Di(cb) is optimized jointly, it may be more beneficial that for example a direct mode is selected for Di(cb) and consequently the prediction error signal for Di(cb) becomes encoded and the prediction parameter selection, such as motion vector prediction, based on decoded Di(cb) may become such that the rate-distortion performance of cb coding is improved. When optimizing the rate and distortion for texture and depth jointly, for example one or more synthesized view may be used to derive the distortion, because texture picture distortion may not be directly comparable to depth picture distortion. The encoder may also select values for syntax elements such a manner that depth/disparity based prediction parameter becomes effective. For example, the encoder may select a skip or direct mode or alike for a current texture block cb when some of the neighboring blocks have similar depth/disparity compared to the depth/disparity of cb and hence depth/disparity based selection of motion vector predictor(s) is likely to succeed well. Likewise, the encoder may avoid selecting a skip or direct mode or alike for cb when no neighboring blocks have similar depth/disparity compared to the depth/disparity of cb.

In some embodiments, the encoder may encode some texture views without depth/disparity based prediction parameter derivation while other texture views may be encoded using depth/disparity based prediction parameter derivation. For example, the encoder may encoder the base view of the texture without depth/disparity based prediction parameter derivation and rather use conventional prediction mechanisms. For example, the encoder may encode a bitstream compatible with the H.264/AVC standard by encoding a base view without depth/disparity based prediction parameter derivation and hence the bitstream can be decoded by H.264/AVC decoders. Likewise, the encoder may encode a bitstream where a set of views is compatible with MVC by encoding a base view and the other views in the set of views without depth/disparity based prediction parameter derivation. Consequently, the set of views can be decoded by MVC decoders.

While many of the embodiments are described for mixed-direction motion-compensated prediction and motion vector prediction for luma, it is to be understood that in many coding arrangements chroma motion information may be derived from luma motion information using pre-determined relations. For example, it may be assumed that the same reference indexes are used for the chroma components as for luma and that the motion vectors of chroma are scaled from the luma motion vectors in the same proportion as the spatial resolution of chroma pictures compared to the spatial resolution of luma pictures.

In some embodiments the spatial resolution of depth/disparity pictures may differ or may be re-sampled in the encoder as a pre-processing operation to become different from that of the luma pictures of texture. In some embodiments, the depth/disparity pictures are re-sampled in the encoding loop and/or the decoding loop to become identical resolution to the respective luma pictures of texture. In other embodiments, the spatially corresponding blocks of depth/disparity pictures are found by scaling the block locations and size proportionally to the ratio of the picture extents of the depth pictures and luma pictures of texture.

For some embodiments, a texture image and the depth image associated with the texture image are presented at different spatial resolution, thus coded block Cb and associated d(Cb) have different size in spatial domain (different number of pixels in horizontal and vertical directions or in either of those).

The encoder may use several methods to indicate the different resolutions of the texture images relative to the resolution of the depth images. For example, the resolution of the texture image and the resolution of the depth image can be separately indicated by an encoder in a sequence parameter set coded into the bitstream. In another example, the encoder may encode two sequence parameter sets, one to be used for decoding texture view components and another to be used for decoding depth view components, where each sequence parameter set includes syntax elements indicating a spatial resolution. In this example, the encoder encodes coded slices for texture with a reference to the sequence parameter set for texture view components and respectively coded slices for depth with a reference to the sequence parameter set for depth view components. The reference for a sequence parameter set may be indirect, e.g. it may be through a reference in a picture parameter set, and the picture parameter set may be indicated in a slice header of a coded slice. The decoder resolves or decodes the reference between syntax structures and uses the signaled spatial resolutions for decoding of a texture view component and depth view component. In some coding schemes, the ratio between a texture resolution and a depth resolution may be pre-defined for example to 1:1 or 2:1 (along both coordinate axes), and no information regarding one of the texture and depth resolution needs to be coded to the bitstream or decoded from the bitstream.

In order to perform proposed motion vector prediction, spatial resolutions of texture and depth images can be normalized (adjusted to a single resolution) by re-sampling (interpolating) of either component (texture or depth) to the resolution of another component (depth or texture, respectively). Resampling to a higher resolution can be implemented by various means, for example by linear-filter interpolation (e.g. bi-linear, cubic, lanczos, or interpolation filters utilized in H.264/AVC or in HEVC), or by non-linear filter upsampling, or by simple duplication of image samples. Resampling to a lower resolution can be implemented by various means, for example by decimation, or decimation with low pass filtering.

The encoder may determine a resampling process, parts thereof, or threshold or other parameter values to be used based on one or more cost functions and by (approximate) minimization/maximization of these one or more cost functions. For example, a peak signal-to-noise ratio (PSNR) of the resampled depth picture relative to the original depth picture may be used as a basis of a cost function. The encoder may perform a rate-distortion optimized selection of one or more of the resampling process, parts thereof, or threshold or other parameter values, where the distortion is based on a selected cost function.

The cost function used by the encoder may also be based on synthesizing a picture, where in the synthesis process the resampled depth picture is used, and applying a similarity measure, such as PSNR, to the synthesized picture.

The encoder may encode indications specifying at least parts of the used resampling method. Such indications may include one or more of the following:
Identification of the used resampling process in encoding and/or to-be-used resampling process in decoding
Thresholds and/or other parameter values for the resampling process

The encoder may encode such indications into various parts of the coded bitstream, such as sequence parameter set, picture parameter set, adaptation parameter set, picture header, or slice header.

A decoder according to the invention may decode from the bitstream indications specifying at least parts of the resampling method used in encoding and/or to be used in decoding. The decoder may then perform the resampling process in accordance with the decoded indications.

In both the encoder and the decoder, the resampling may take place in the (de)coding loop, i.e. upsampled depth may be used in other (de)coding processes. The upsampling may take place for a complete picture or a part of a picture, such as a set of contiguous lines of samples for example covering a line of coding blocks.

In some embodiments, motion information MV(A) and MV(B) of first adjacent texture block A and the second adjacent texture block B respectively is represented with a specific accuracy (e.g. ¼-pixel location accuracy of motion vectors in the H.264/AVC standard, or with ⅛-pixel location accuracy in others). In these embodiments in-loop upsampling of a reference image by factor of 4× along both horizontal and vertical axis may be performed at both encoder and decoder side to perform motion or disparity compensated prediction. Respectively, motion vector components of MV(A) and MV(B) resulting from such motion estimations are represented and processed at the 4× of the original image resolution. To perform proposed MVP in such embodiments, both texture and depth data may be up-sampled to this particular resolution, which may be referred to as common upsampled in-loop resolution. The up-sampling can be implemented for an entire frame (usually done in the encoder), or interpolation can be performed locally, e.g. at block level (usually done in the decoder).

In some embodiments, motion vector components of MV(A) and MV(B) of adjacent texture blocks A and B, respectively, may be rescaled to meet the spatial resolution of the depth image instead of resampling of the depth image. For example, if MV(A) and MV(B) of texture data are represented at the original texture resolution and the resolution of depth is smaller than resolution of texture, motion vector components (mv_x and mv_y) of MV(A) and MV(B) are downscaled by ratio at which resolution of texture and depth data are different). The downscaling of motion vector components may be followed by quantizing the downscaled motion vector components to certain accuracy, where the quantization operation may include rounding for example towards the closest quantization level. The quantization may be selected such a manner that no resampling of the depth picture is necessary or resampling is performed to a smaller resolution than what would be needed without quantization. The resolution to which the depth pictures are resampled in the coding or decoding loop in order to perform the proposed MVP may be referred to as the in-loop depth resolution. For example, the depth picture may have a resolution half of that of the luma texture picture along both coordinates axes (e.g. luma texture picture has resolution 1024×768 and depth picture has resolution 512×384) and the motion vector components of the luma texture component have ¼-pixel accuracy (e.g. mv_x is equal to 5.25 and mv_y is equal to 4.25). Then the motion vector components to be utilized for depth in the proposed MVP are scaled by a ratio of 2 (e.g. mv_x equal to 2.625 and mv_y equal to 2.125, with reference to the same example as before) and would therefore have ⅛-pixel accuracy within the depth picture. In order to avoid resampling of depth, the scaled motion vector components may be quantized to integer-pixel accuracy within the depth picture (e.g. mv_x equal to 3 and mv_y equal to 2, with reference to the sample example as before). In another example, the scaled motion vector components may be quantized to half-pixel accuracy within the depth picture (e.g. mv_x equal to 2.5 and mv_y equal to 2, with reference to the sample example as before) and the depth picture therefore needs to be upsampled by a factor of 2 along both coordinate axes (e.g. 1024×768, with reference to the same example as before), where upsampling may be performed for example using bilinear upsampling. Such implementations of the proposed MVP would allow avoiding resampling of the depth data to the required resolution, and may have lower computational complexity.

The encoder may encode indications or syntax elements specifying motion vector scaling to be used in the proposed MVP. Such indications may include one or more of the following:
The in-loop depth resolution.
The accuracy to which the motion vector components are scaled to, for example ¼, ½, or full pixel accuracy.
The method for quantizing, for example whether negative motion vector components exactly in the middle of two quantization levels are scaled towards or away from zero. For example, if full-pixel accuracy is used, such an indication would indicate whether motion vector component value −0.5 is rounded to 0 or −1.

The encoder may encode such indications into various parts of the coded bitstream, such as sequence parameter set, picture parameter set, adaptation parameter set, picture header, or slice header.

A decoder according to the invention may decode from the bitstream indications specifying the depth motion vector scaling to be used in the proposed MVP. The decoder may then perform the motion vector scaling accordingly and subsequently uses the scaled motion vectors in the proposed MVP for texture.

In some embodiments, a similarity metric which is utilized in the proposed MVP can be adjusted to use a different block size and/or shape for the similarity comparison than the block size and/or shape of cb. For example, if the in-loop depth resolution differs from the in-loop luma texture resolution, the block size of the similarity comparison may be changed according to the ratio of the in-loop depth resolution to in-loop luma texture resolution. For example, if the in-loop luma texture resolution is double of the in-loop depth resolution along both coordinate axes, a block size half of cb along both coordinate axes may be used for similarity comparison.

In some embodiments, a similarity metric which is utilized in the MVP can be adjusted to reflect the difference in spatial resolution between texture or depth data. For example, if the depth picture has been resampled for the proposed MVP to the common upsampled in-loop resolution, the similarity metric which is utilized in the MVP can be adjusted according to the ratio the depth resampling was performed. Said adjustment may be implemented through decimation or subsampling, if the resolution of depth data is higher than the resolution of motion vectors, or through interpolation or upsampling of depth information d(MV(A), d(cb)) if the resolution of depth is smaller than the resolution of texture data or motion vectors (MV(A), MV(B)). For example if the spatial resolution of luma texture data is double of the spatial resolution of depth data along both coordinate axes and depth is resampled to the common upsampled in-loop resolution, every other depth pixel along both coordinate axes in the depth picture at the common upsampled in-loop resolution may be included in the calculations of the similarity method.

The encoder may encode indications or syntax elements specifying the similarity metric use with the proposed MVP. Such indications may include one or more of the following:
The common upsampled in-loop resolution
The decimation scheme and ratio to be used when selecting depth pixels for the similarity metric calculation. For example, it could be indicated that every other depth pixel (along both coordinate axes) from the depth picture at the common upsampled in-loop resolution is used in the similarity metric calculation.
The block size or a ratio indicating the block size relation between texture and depth images to be used in the similarity metric calculation. For example, it could be indicated that a block size half of the size of the current text block cb along both coordinate axes is used for the similarity metric.

The encoder may encode such indications into various parts of the coded bitstream, such as sequence parameter set, picture parameter set, adaptation parameter set, picture header, or slice header.

A decoder according to the invention may decode from the bitstream indications specifying the similarity metric calculation to be used in the proposed MVP. The decoder may then perform the indicated similarity metric calculation in the proposed MVP for texture.

For some other embodiments, texture and associated depth images can be represented with different sampling method. For example, each of partition of coded texture data (PU, 4×4, 8×8, 16×8, 8×16 blocks and others) may be associated with a single depth value which would represent an average depth value for a current partition of texture. This format for depth image can be considered as non-uniform depth data representation, and may be different from a typical sampling scheme utilized for texture data images (uniform sampling).

FIG. 20 shows an example of such a representation, where the gray rectangle on the right shows borders of a texture image with regular sampling, the gray rectangle on the left shows depth image borders associated with this texture data. Blocks {Cb1-Cb3} of texture image consist of a group of texture image pixels represented with uniform sampling scheme. The depth information {d(Cb1)-d(Cb3)} however is represented a single depth value per texture blocks {Cb1-Cb3}, and these values are shown in red circles at the left of image below. With such representation, referenced depth blocks d(MV(A), d(Cb)) and d(MV(B), d(Cb)) may not be accessed directly and some operations for depth value extraction may have to be performed.

Let's consider FIG. 20, referenced texture block X is addressed by MV(A) from the Cb locations, and the spatial size of block X is equal to the spatial size of Cb block. In reference texture image, block X may overlap several partitions of the texture data (which are marked as

Cb1, Cb2, Cb3) and which are represented with uniform sampling. Since the depth data is represented in non-uniform sampling, referenced block d(X), which is equal to d(MV(A), d(Cb)) covers depth area which is represented with several depth map values {d(Cb1), d(Cb2), d(Cb3)}, shown as red circles within white blocks areas.

To perform MVP in such a case depicted in FIG. 20, a depth value d(X) for the referenced texture block X need to be extracted from available non-uniform sampled depth data {d(Cb1), d(Cb2) and d(Cb3)} or their neighbors by a resampling method. Examples of such resampling may include linear or non-linear operations of fusing (merging) or averaging of available depth samples which happen to represent referenced blocks d(X) in such non-uniform representation. In some cases, depth data from additional depth samples in neighborhood of {d(Cb1), d(Cb2), d(Cb3)} may be used to improve depth estimation process.

For some embodiments, depth data at non-uniform representation can be transmitted within syntax elements of coded texture image, e.g. at the slice header or within coded texture block syntax structures. In such embodiments, operation of d(X) calculation would require extraction of depth information from syntax elements of Cb1-Cb3 and following fusing/merging or aggregating depth information d(Cb1)-d(Cb3) or other to produce d(X) data.

In some other embodiments, depth data at non-uniform representation for corresponding blocks Cb1-Cb3 can be extracted/estimated/produced at the decoder side from available multiview representation of texture data. In such embodiments, operation of d(X) calculation would require estimation depth information for texture blocks Cb1-Cb3 from available multiview representation of texture data for following fusing/merging or aggregating depth information d(Cb1)-d(Cb3) or other to produce d(X) data.

In the following, two example methods are described by which a suitable estimate for the depth map of the current texture view component can be derived based on already transmitted information.

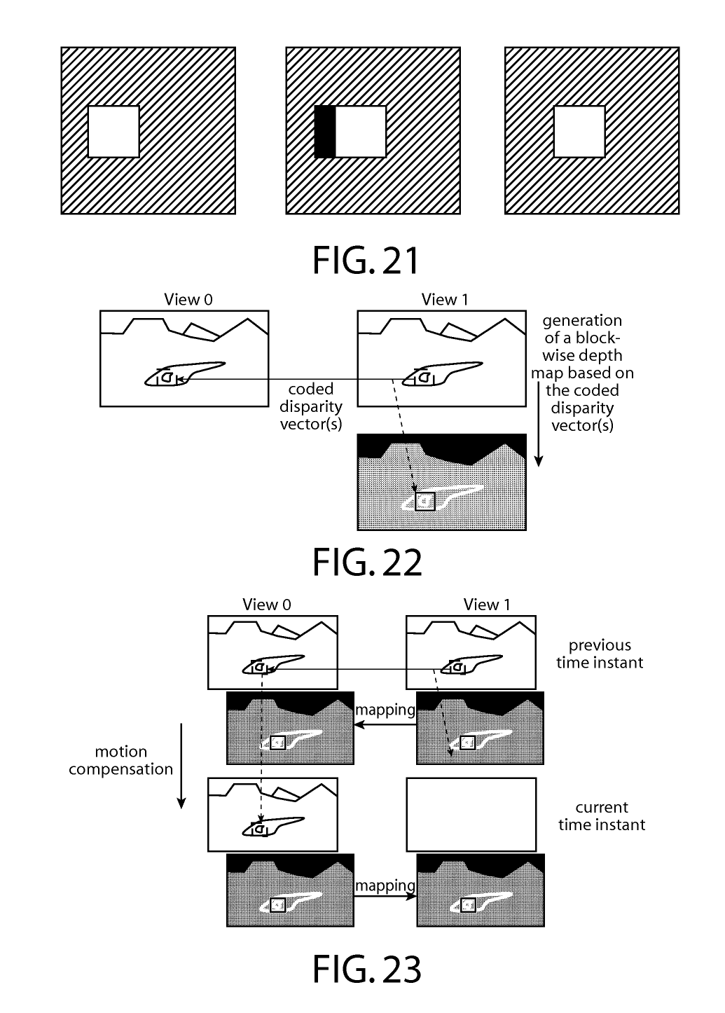

In the first method the depth data is transmitted as a part of the bitstream, and a decoder using this method decodes the depth maps of previously coded views for decoding dependent views. In other words, the depth map estimate can be based on an already (de)coded depth map of another view of the same access unit or picture sampling instant. If the depth map for a reference view is coded before the current picture, the reconstructed depth map can be mapped or warped or view-synthesized into the coordinate system of the current picture for obtaining a suitable depth map estimate for the current picture. In FIG. 21, such a mapping is illustrated for a simple depth map, which consists of a square foreground object and background with constant depth. For each sample of the given depth map, the depth sample value is converted into a sample-accurate disparity vector. Then, each sample of the depth map is displaced by the disparity vector. If two or more samples are displaced to the same sample location, the sample value that represents the minimal distance from the camera (i.e., the sample with the larger value in some embodiments) is chosen. In general, the described mapping leads to sample locations in the target view to which no depth sample value is assigned. These sample locations are depicted as a black area in the middle of the picture of FIG. 21. These areas represent parts of the background that are uncovered due to the movement of the camera and can be filled using surrounding background sample values. A simple hole filling algorithm may be used which processes the converted depth map line by line. Each line segment that consists of a successive sample location to which no value has been assigned is filled with the depth value of the two neighboring samples that represent a larger distance to the camera (i.e., the smaller depth value in some embodiments).

The left part of FIG. 21 illustrates the original depth map; the middle part illustrates the converted depth map after displacing the original samples; and the right part illustrates the final converted depth map after filling of holes.

In the second example method the depth map estimate is based on coded disparity and motion vectors. In random access units, all blocks of the base view picture, are intra-coded. In the pictures of dependent views, most blocks are typically coded using disparity-compensated prediction (DCP, also known as inter-view prediction) and the remaining blocks are intra-coded. When coding the first dependent view in a random access unit, no depth or disparity information is available. Hence, candidate disparity vectors can only be derived using a local neighborhood, i.e., by conventional motion vector prediction. But after coding the first dependent view in a random access unit, the transmitted disparity vectors can be used for deriving a depth map estimate, as it is illustrated in FIG. 22. Therefore, the disparity vectors used for disparity-compensated prediction are converted into depth values and all depth samples of a disparity-compensated block are set equal to the derived depth value. The depth samples of intra-coded blocks are derived based on the depth samples of neighboring blocks; the used algorithm is similar to spatial intra prediction. If more than two views are coded, the obtained depth map can be mapped into other views using the method described above and used as a depth map estimate for deriving candidate disparity vectors.

The depth map estimate for the picture of the first dependent view in a random access unit is used for deriving a depth map for the next picture of the first dependent view. The basic principle of the algorithm is illustrated in FIG. 23. After coding the picture of the first dependent view in a random access unit, the derived depth map is mapped into the base view and stored together with the reconstructed picture. The next picture of the base view may typically be inter-coded. For each block that is coded using a motion compensated prediction (MCP), the associated motion parameters are applied to the depth map estimate. A corresponding block of depth map samples is obtained by motion compensated prediction with the same motion parameters as for the associated texture block; instead of a reconstructed video picture the associated depth map estimate is used as a reference picture. In order to simplify the motion compensation and avoid the generation of new depth map values, the motion compensated prediction for depth block may not involve any interpolation. The motion vectors may be rounded to sample-precision before they are used. The depth map samples of intra-coded blocks are again determined on the basis of neighboring depth map samples. Finally, the depth map estimate for the first dependent view, which is used for the inter-view prediction of motion parameters, is derived by mapping the obtained depth map estimate for the base view into the first dependent view.

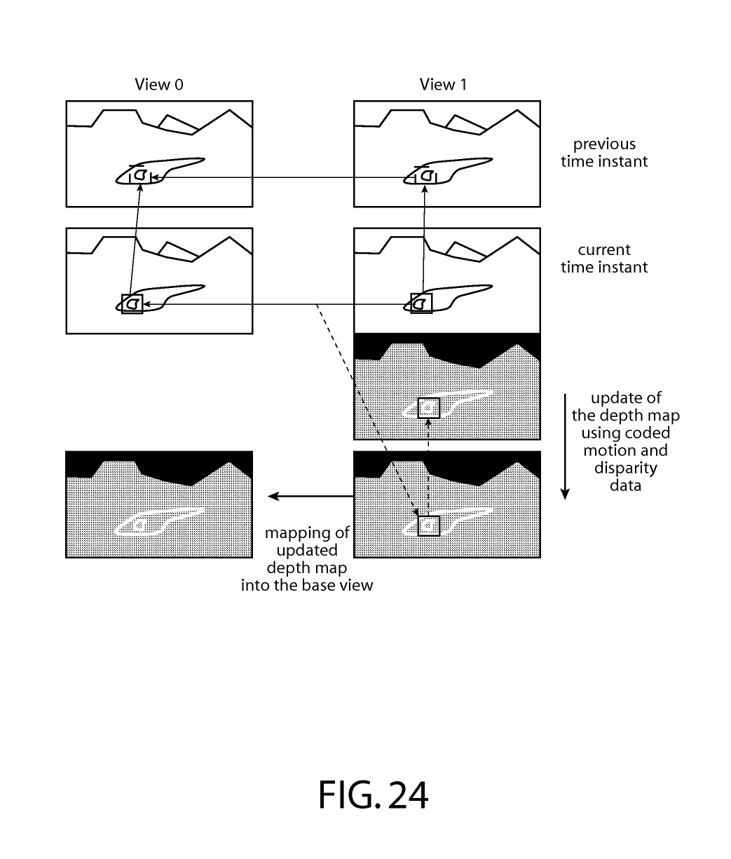

After coding the second picture of the first dependent view, the estimate of the depth map is updated based on actually coded motion and disparity parameters, as it is illustrated in FIG. 24. For blocks that are coded using disparity-compensated prediction, the depth map samples are obtained by converting the disparity vector into a depth value. The depth map samples for blocks that are coded using motion compensated prediction can be obtained by motion compensated prediction of the previously estimated depth maps, similar as for the base view. In order to account for potential depth changes, a mechanism by which new depth values are determined by adding a depth correction may be used. The depth correction is derived by converting the difference between the motion vectors for the current block and the corresponding reference block of the base view into a depth difference. The depth values for intra-coded blocks are again determined by a spatial prediction. The updated depth map is mapped into the base view and stored together with the reconstructed picture. It can also be used for deriving a depth map estimate for other views in the same access unit.

For the following pictures, the described process is repeated. After coding the base view picture, a depth map estimate for the base view picture is determined by motion compensated prediction using the transmitted motion parameters. This estimate is mapped into the second view and used for the inter-view prediction of motion parameters. After coding the picture of the second view, the depth map estimate is updated using the actually used coding parameters. At the next random access unit, the inter-view motion parameter prediction is not used, and after decoding the first dependent view of the random access unit, the depth map may be re-initialized as described above.

For some other embodiments, proposed MVP scheme can be combined with other motion vector prediction schemes, such as MVP of H.264/AVC or MVP of High Efficiency Video Coding (HEVC) development. For example, for that MVD content where available depth information is not accurate or noisy, proposed MVP scheme can be adaptively supplemented with alternative MVP schemes.

Decision making on application of the competing MVP schemes may be performed at the encoder side and may be signaled to the decoder over the bitstream. MVP selection for example can be based on frame-level rate-distortion optimization. In this embodiment a frame is coded with different MVP schemes, and MVP which provides minimal rate-distortion cost is selected and signaled at the picture parameter set (PPS), adaptation parameter set (APS), picture header, slice header, or anything alike. Alternatively, MVP selection can be implemented at the slice, block, or the block partition level and an MVP index or a similar indication indicating the MVP scheme in use is signaled in the slice header or the block syntax structure prior to a decoded block partition. In such embodiments, decoder extracts the MVP index or a similar indication from the bitstream and configures decoding process accordingly.

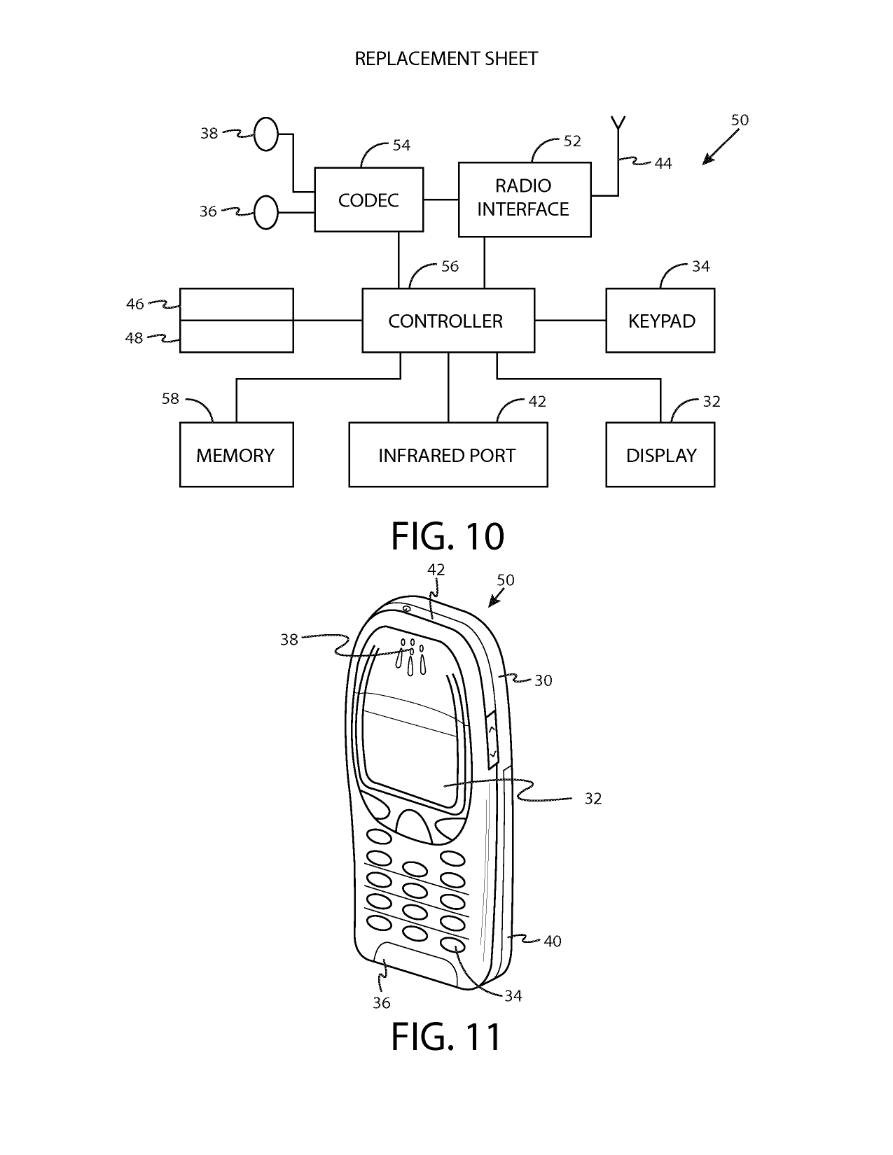

The following describes in further detail suitable apparatus and possible mechanisms for implementing the embodiments of the invention. In this regard reference is first made to FIG. 10 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In other embodiments of the invention, the apparatus may receive the video image data for processing from another device prior to transmission and/or storage. In other embodiments of the invention, the apparatus 50 may receive either wirelessly or by a wired connection the image for coding/decoding.

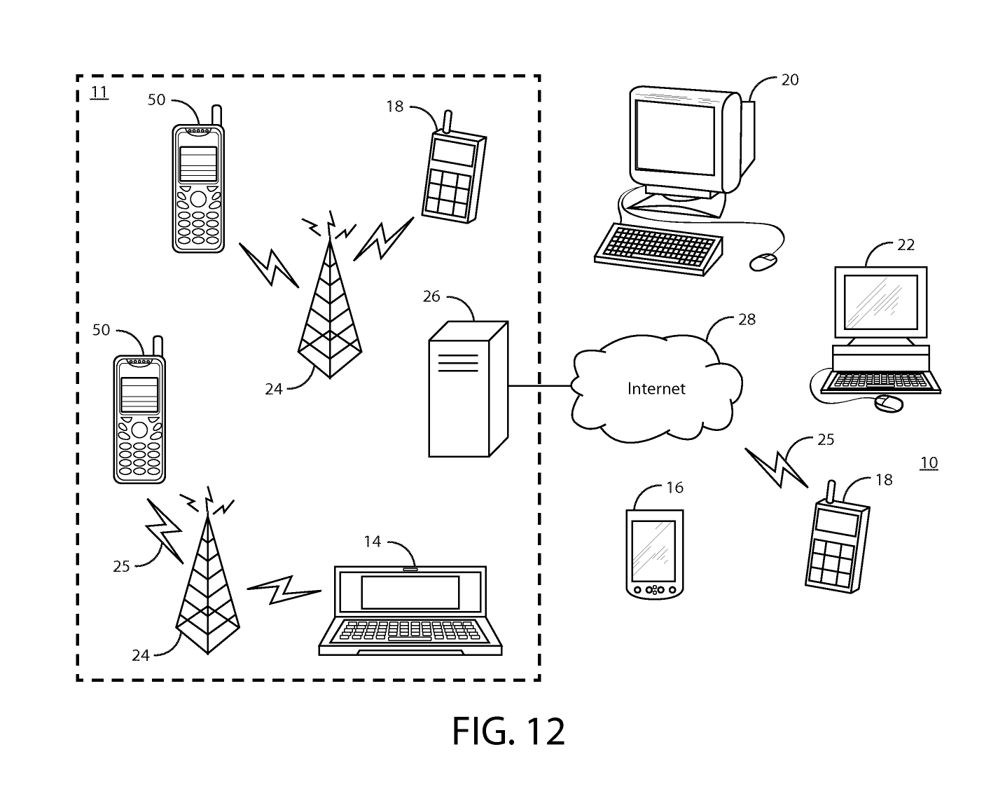

With respect to FIG. 12, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 12 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the interne 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

What is claimed is:

1. A method comprising:
decoding, from a bitstream, a first coded texture block of a first coded texture picture into a first texture block, wherein the decoding the first coded texture block comprises:
obtaining a first depth/disparity block spatially co-located with the first texture block;
deriving a disparity motion vector from the first depth/disparity block;
using the disparity motion vector in motion vector prediction for the first texture block; and
decoding the first coded texture block using motion vector prediction.

2. The method according to claim 1, further comprising
deriving a list of candidate motion vectors; and
decoding, from the bitstream, an index of a selected motion prediction candidate in the list of candidate motion vectors.

3. An apparatus comprising a video decoder configured for
decoding, from a bitstream, a first coded texture block of a first coded texture picture into a first texture block, wherein the decoding the first coded texture block comprises:
obtaining a first depth/disparity block spatially co-located with the first texture block;
deriving a disparity motion vector from the first depth/disparity block;
using the disparity motion vector in motion vector prediction for the first texture block; and
decoding the first coded texture block using motion vector prediction.

4. The apparatus according to claim 3, wherein the video decoder is configured to:
derive a list of candidate motion vectors; and
decode, from the bitstream, an index of a selected motion prediction candidate in the list of candidate motion vectors.

5. A computer readable storage medium stored with code thereon for use by an apparatus, which when executed by a processor, causes the apparatus to perform:
decoding, from a bitstream, a first coded texture block of a first coded texture picture into a first texture block, wherein the decoding the first coded texture block comprises:
obtaining a first depth/disparity block spatially co-located with the first texture block;
deriving a disparity motion vector from the first depth/disparity block;
using the disparity motion vector in motion vector prediction for the first texture block; and
decoding the first coded texture block using motion vector prediction.

6. An apparatus comprising at least one processor and at least one memory, said at least one memory stored with code thereon, which when executed by said at least one processor, causes an apparatus to perform:
decoding, from a bitstream, a first coded texture block of a first coded texture picture into a first texture block, wherein the decoding the first coded texture block comprises:
obtaining a first depth/disparity block spatially co-located with the first texture block;
deriving a disparity motion vector from the first depth/disparity block;
using the disparity motion vector in motion vector prediction for the first texture block; and
decoding the first coded texture block using motion vector prediction.

7. A method comprising:
encoding, a first coded texture block of a first coded texture picture into a first texture block, wherein the encoding of the first coded texture block comprises:
obtaining a first depth/disparity block spatially co-located with the first texture block;
deriving a disparity motion vector from the first depth/disparity block;
using the disparity motion vector in motion vector prediction for the first texture block; and
encoding the first coded texture block using motion vector prediction.

8. The method according to claim 7, further comprising
deriving a list of candidate motion vectors; and
encoding an index identifying the disparity motion vector in the list of candidate motion vectors.

9. An apparatus comprising a video encoder configured for
encoding, a first coded texture block of a first coded texture picture into a first texture block, wherein the encoding of the first coded texture block comprises:
obtaining a first depth/disparity block spatially co-located with the first texture block;
deriving a disparity motion vector from the first depth/disparity block;
using the disparity motion vector in motion vector prediction for the first texture block; and
encoding the first coded texture block using motion vector prediction.

10. The apparatus according to claim 9, wherein the video decoder is configured to:
derive a list of candidate motion vectors; and
encode an index identifying the disparity motion vector in the list of candidate motion vectors.

11. A computer readable storage medium stored with code thereon for use by an apparatus, which when executed by a processor, causes the apparatus to perform:
encoding, a first coded texture block of a first coded texture picture into a first texture block, wherein the encoding of the first coded texture block comprises:
obtaining a first depth/disparity block spatially co-located with the first texture block;
deriving a disparity motion vector from the first depth/disparity block;
using the disparity motion vector in motion vector prediction for the first texture block; and
encoding the first coded texture block using motion vector prediction.

12. An apparatus comprising at least one processor and at least one memory, said at least one memory stored with code thereon, which when executed by said at least one processor, causes an apparatus to perform:
encoding, a first coded texture block of a first coded texture picture into a first texture block, wherein the encoding of the first coded texture block comprises:
obtaining a first depth/disparity block spatially co-located with the first texture block;
deriving a disparity motion vector from the first depth/disparity block;
using the disparity motion vector in motion vector prediction for the first texture block; and
encoding the first coded texture block using motion vector prediction.
